(19) United States
(12) Patent Application Publication
(10) Pub. No.: US 2026/0257747 A1
(43) Pub. Date: Sep. 3, 2026

(54) MULTI-FUNCTIONAL SCOOTER AND CARGO HOLD

(71) Applicant: ARTFUL DESIGN GROUP, LLC, Phoenix, AZ (US)

(72) Inventors: Donald A. Parker, Oakland, CA (US); Kenneth I. Li, Piedmont, CA (US); Katherine A. Warshaw, Berkeley, CA (US); Tom B. Martin, Aptos, CA (US)

(73) Assignee: ARTFUL DESIGN GROUP, LLC, Phoenix, AZ (US)

(21) Appl. No.: 19/655,084

(22) Filed: Apr. 22, 2026

Related U.S. Application Data
(63) Continuation-in-part of application No. PCT/US24/52036, filed on Oct. 18, 2024.

(51) Int. Cl. B62K 5/007; B60L 53/51; B62B 3/02; B62B 5/06; B62J 1/08; B62J 7/02; B62J 43/16; B62K 15/00; B62K 27/12

(52) U.S. Cl. CPC B62K 5/007; B60L 53/51; B62B 3/02; B62B 5/067; B62J 1/08; B62J 7/02; B62J 43/16; B62K 15/006; B62K 27/12; B60L 2200/12; B62J 2001/085; B62K 2204/00

(57) ABSTRACT

Scooters having two wheels, a frame, and a cargo hold (e.g., in front of the user) that accepts and stows (e.g., is configured to carry) a (e.g., folded) rear part of the scooter, for example, detached to transform from being rideable to a shopping cart. Two auxiliary wheels may be deployed to convert to the shopping cart, which may roll on three wheels, for example, pushed by the user. The scooter may have a seat, an (e.g., telescoping) seat column, a strut adjuster (e.g., for fore and aft seat adjustment), or a combination thereof. The cargo hold may be configured to be disconnected from the scooter and pushed or pulled on four wheels by the user, for example, with a telescoping handle. The scooter may include: a kingpin (e.g., cam actuated), an electric motor, a battery, a controller, a solar panel, or a combination thereof.

### RELATED PATENT APPLICATIONS

This US non-provisional patent application is a Continuation in Part (CIP) Patent Application of, claims priority to, and incorporates by reference: international patent application serial number PCT/US24/52036, filed under the Patent Cooperation Treaty (PCT) on Oct. 18, 2024, MULTI-FUNCTIONAL SCOOTER AND CARGO HOLD, which is a Continuation in Part (CIP) Patent Application of, claims priority to, and incorporates by reference, U.S. Provisional Patent Application Ser. No. 63/592,876, Filed Oct. 24, 2023, which has the same title and common inventors. This US non-provisional patent application also incorporates by reference U.S. Provisional Patent Application Ser. No. 63/405,416 filed 10 Sep. 2022, which has common inventors.

### FIELD OF THE INVENTION

Various embodiments of this invention relate to scooters and cargo holds for scooters, including electric and human powered scooters, foldable scooters, scooters with adjustable seats, scooters with auxiliary wheels, scooters that convert to carts, scooters with cargo holds, and cargo holds that work with both scooters and bicycles.

### BACKGROUND OF THE INVENTION

In the past, various human-powered and electric scooters have been built and used for transportation of people and certain cargo. Vehicles have been devised and used with two, three, or more wheels, and many have included a frame, seat, or both. Various prior vehicles have included scooters, tricycles, bicycles, and various velocipedes. Brakes, handlebars, decks, and baskets have been used in different combinations. Some have had folding frames, for example, with one or more pivot points where the frame folded, for instance, to make the vehicle more compact. Various problems have been encountered in prior technology, however, including the inability or difficulty with bringing and securing these vehicles in certain public settings, including retail environments. Needs or potential for benefit exist for better scooters, including foldable scooters, scooters with seats that are adjustable (e.g., in a fore and aft direction), and scooters that convert into a shopping cart, trolley, or hand truck, as examples. Room for improvement exists over the prior art in these and other areas that may be apparent to a person of skill in the art having studied this document.

### SUMMARY OF PARTICULAR EMBODIMENTS OF THE INVENTION

This invention provides, among other things, improved scooters including foldable scooters, scooters with seats that are adjustable (e.g., in a fore and aft direction), scooters with cargo holds (e.g., cargo boxes), auxiliary wheels, or both, and scooters that convert to a cart, for example, a shopping cart for use in a retail establishment. Various embodiments provide, for example, as an object or benefit, that they partially or fully address or satisfy one or more of the needs, potential areas for benefit, or opportunities for improvement described herein, or known in the art, as examples. Certain embodiments provide, for example, as objects or benefits, for instance, that: when the scooter is folded, the scooter is configured to be rolled on the ground by the user on the wheels of the scooter, for transportation of the scooter; or include a strut adjuster, for example, configured to be adjusted by the user to adjust fore and aft position of the seat. Different embodiments convert to a cart, trolley, hand truck, or a combination thereof, and in some embodiments, the cart, trolley, or hand truck can hold the remainder of the scooter, for instance, while shopping. Further, certain cargo holds are usable either with a scooter or with a (e.g., electric) bicycle. Various embodiments are better than prior art alternatives in one or more ways, for instance, as described herein or as would be apparent to a person of ordinary skill in the art who studied this document.

Specific embodiments include various scooters having a first wheel, a second wheel, a frame, and a cargo hold, for example, where the cargo hold accepts and stows a rear part of the scooter that is detached from a front part of the scooter, for instance, to transform the scooter from a deployed rideable state into a configuration to be used as a shopping cart, for example, so that a user can keep the scooter with the user while in a retail environment. In some embodiments, two auxiliary wheels may be deployed, for example, to contact the ground, for instance, to convert the scooter into the configuration to be used as the shopping cart. Further, in particular embodiments, the shopping cart may roll on at least three wheels while in that configuration, the shopping cart may be pushed by the user in front of the user while the user is walking, or both. Still further, in certain embodiments, the cargo hold may be specifically configured to carry the rear part of the scooter, the front wheel of the scooter may also serve as the front wheel of the shopping cart, or both. Even further, in some embodiments, the rear part of the scooter may be folded, for example, before being stowed in the rear part of the scooter.

Further still, in some embodiments, the scooter has a seat that a user can (e.g., optionally) sit on, for instance, when riding the scooter, a seat column that supports the seat, for example, from the frame, a strut adjuster, for instance, that extends (e.g., from the frame) to the seat column, or a combination thereof. The strut adjuster may be configured to be adjusted by the user, for example, to adjust fore and aft position of the seat, for instance, by altering length of the strut adjuster. Even further still, in some embodiments, the seat column may pivot, for example, where the seat column connects to the frame. Moreover, in particular embodiments, the seat column may include a telescoping seat tube, for instance, configured to be adjusted by the user, for example, to adjust height of the seat.

Furthermore, in certain embodiments, the cargo hold may be mounted in front of the user, for example, when the user is riding on the scooter. In addition, in particular embodiments, the cargo hold includes four cargo hold wheels, and the cargo hold may be configured to be disconnected from the scooter and pushed or pulled on the four cargo hold wheels by the user, for example, when the user is walking. Further, the scooter may have a telescoping handle, for instance, that the user uses to push or pull the cargo hold, for example, when the cargo hold is disconnected from the scooter. Further still, in some embodiments, the scooter has a kingpin (e.g., cam actuated), the front part of the scooter separates from the rear part of the scooter with the kingpin, or both. Still further, in particular embodiments, the scooter includes an electric motor, for example, that drives the first wheel, a battery, for instance, that powers the electric motor, a controller, for example, that controls the electric motor, or a combination thereof. Even further, in certain embodiments, the scooter has a solar panel, for example, that charges the battery. Various other embodiments are also described herein or would be apparent to a person of ordinary skill in the art having studied this document.

### BRIEF DESCRIPTION OF THE DRAWINGS

The drawings provided herewith illustrate, among other things, examples of certain aspects of particular embodiments. Other embodiments may differ. Various embodiments may include aspects shown in the drawings, described in the specification (including the claims), known in the art, or a combination thereof, as examples. Other drawings are included in the patent applications that are incorporated by reference herein.

FIG. 1 is a partially-exploded side view of a foldable scooter that includes a seat that a user can (e.g., optionally) sit on when riding the scooter, a seat column that supports the seat from the frame, and a strut adjuster that extends from the frame to the seat column, and the strut adjuster is configured to be adjusted by the user to adjust fore and aft position of the seat;

FIG. 2 is a partially-exploded isometric view of a rear part of a foldable scooter that includes a seat that a user can (e.g., optionally) sit on when riding the scooter and a seat column that supports the seat from the frame, which illustrates, among other things, the rear hinge of the scooter;

FIG. 3 is a partially-exploded isometric view of a seat that a user can (e.g., optionally) sit on when riding the scooter and a seat column that supports the seat from the frame of a scooter;

FIG. 4 is a side view of a foldable scooter that includes a seat that a user can (e.g., optionally) sit on when riding the scooter and a seat column that supports the seat from the frame of the scooter;

FIG. 5 is a top view of the scooter of FIG. 4;

FIG. 6 is a rear view of the scooter of FIG. 4;

FIG. 7 is a partially-exploded isometric view of a front part of the scooter of FIG. 4, which illustrates, among other things, the front hinge of the scooter;

FIG. 8 is a side view of the scooter of FIG. 4 shown with the scooter separated into three parts;

FIG. 9 is an isometric view of an electric cargo scooter that includes, among other things, a first wheel, a second wheel, a frame, a cargo hold that is a cargo box, auxiliary wheels, a seat that a user can (e.g., optionally) sit on when riding the scooter, and a seat column that supports the seat from the frame;

FIG. 10 is another isometric view of the electric cargo scooter of FIG. 9 that illustrates, among other things, a partially-exploded front part of the scooter;

FIG. 11 is a partially-exploded isometric view of a rear part of the electric cargo scooter of FIG. 9;

FIG. 12 is another isometric view of the electric cargo scooter of FIG. 9 except with a quick-release foldable cargo box as the cargo hold;

FIG. 13 is an isometric view of a front part of the electric cargo scooter of FIG. 9 that that has been converted to cart mode;

FIG. 14 is another isometric view of the electric cargo scooter of FIG. 9 or FIG. 12 except with a non-quick-release foldable cargo box shown in a stowed position;

FIG. 15 is an isometric view of the electric cargo scooter of FIG. 14 except shown with the non-quick-release foldable cargo box in a deployed position;

FIG. 16 is a side view of another foldable electric scooter that includes a seat that a user can optionally sit on when riding the scooter, a seat column that supports the seat from the frame, and a strut adjuster that extends from the frame to the seat column, and the strut adjuster is configured to be adjusted by the user to adjust fore and aft position of the seat;

FIG. 17 is a top view of the scooter of FIG. 16;

FIG. 18 is a rear view of the scooter of FIG. 16;

FIG. 19 is an isometric view of the scooter of FIG. 16;

FIG. 20 is a partially-exploded isometric view of a front part of the scooter of FIG. 16, that illustrates, among other things, a front hinge of the scooter;

FIG. 21 is a side view of the scooter of FIG. 16 shown with the scooter separated into three parts;

FIG. 22 is a partially-exploded isometric view of a rear part of the scooter of FIG. 16, that illustrates, among other things, a rear hinge of the scooter and an electric motor within the hub of the rear wheel of the scooter;

FIG. 23 is a side view of an electric cargo scooter that includes, among other things, a first wheel, a second wheel, a frame, auxiliary wheels (one shown), a seat that a user can optionally sit on when riding the scooter, a seat column that supports the seat from the frame, a strut adjuster that extends from the frame to the seat column, where the strut adjuster is configured to be adjusted by the user to adjust fore and aft position of the seat, and a cam-actuated kingpin, but that is shown without a cargo hold, and the front part of the scooter is shown separated from the rear part of the scooter with the kingpin;

FIG. 24 is an isometric view of the electric cargo scooter of FIG. 23 also shown with the front part of the scooter separated from the rear part of the scooter with the kingpin;

FIG. 25 is a detailed side view of part of the electric cargo scooter of FIG. 23 also shown with the front part of the scooter separated from the rear part of the scooter with the kingpin, and illustrating the removeable cam-actuated kingpin;

FIG. 26 is a detailed isometric view of part of the electric cargo scooter of FIG. 23 also shown with the front part of the scooter separated from the rear part of the scooter with the kingpin, and also illustrating the removeable cam-actuated kingpin;

FIG. 27 is an isometric view of a front part of the electric cargo scooter of FIG. 23 that that has been converted to cart mode;

FIG. 28 is a detailed isometric view of part of the front part of the electric cargo scooter of FIG. 27 that that has been converted to cart mode, showing a mechanism for stowing and deploying auxiliary wheels or cart wheels of the scooter;

FIG. 29 is a side view of the front part of the electric cargo scooter of FIG. 27 that that has been converted to cart mode;

FIG. 30 is a rear view of the front part of the electric cargo scooter of FIG. 27 that that has been converted to cart mode;

FIG. 31 is an isometric view of an electric cargo scooter that includes, among other things, a first wheel, a second wheel, a frame, a cargo hold that is a cargo box, auxiliary wheels, a seat that a user can (e.g., optionally) sit on when riding the scooter, a seat column that supports the seat from the frame, a strut adjuster that extends from the frame to the seat column, where the strut adjuster is configured to be adjusted by the user to adjust fore and aft position of the seat, and a quick-release support brace;

FIG. 32 is a detailed isometric view of part of the electric cargo scooter of FIG. 31 that better illustrates the quick-release support brace;

FIG. 33 is a detailed isometric view of just the quick-release support brace of FIGS. 31 and 32;

FIG. 34 is an exploded detailed isometric view of the quick-release support brace of FIG. 33;

FIG. 35 is a side view of the electric cargo scooter of FIG. 31 also separately showing a side view of the quick-release support brace;

FIG. 36 is a top view of the electric cargo scooter of FIG. 31;

FIG. 37 is a front view of the electric cargo scooter of FIG. 31;

FIG. 38 is a side view of the electric cargo scooter of FIG. 31 showing: the front part of the scooter separated from the rear part of the scooter with the kingpin, and the quick-release support brace and the front part of the scooter in the configuration to be used as a (e.g., shopping) cart;

FIG. 39 is a side view of the electric cargo scooter of FIGS. 31-38 showing the front part of the scooter separated from the rear part of the scooter with the kingpin and the quick-release support brace and also showing the rear part of the scooter folded at the rear hinge;

FIG. 40 is a side view of the electric cargo scooter of FIGS. 31-39 showing the front part of the scooter separated from the rear part of the scooter with the kingpin and the quick-release support brace and also showing the folded rear part of the scooter over the cargo hold of the front part of the scooter and oriented to be stowed in the cargo hold;

FIG. 41 is a side view of the electric cargo scooter of FIGS. 31-40 showing the folded rear part of the scooter stowed within the cargo hold of the front part of the scooter (e.g., so that a user can keep the scooter with the user while in a retail environment);

FIG. 42 is a rear view of the electric cargo scooter of FIG. 41 showing the folded rear part of the scooter stowed within the cargo hold of the front part of the scooter;

FIG. 43 is a top view of the electric cargo scooter of FIGS. 41 & 42 showing the folded rear part of the scooter stowed within the cargo hold of the front part of the scooter;

FIG. 44 is an isometric view of the electric cargo scooter of FIGS. 41-43 showing the folded rear part of the scooter stowed within the cargo hold of the front part of the scooter;

FIG. 45 is an isometric view of part of the electric cargo scooter of FIG. 31 showing the cargo hold disconnected from the scooter and configured to be pushed or pulled by the user when the user is walking;

FIG. 46 is a front view of the part of the electric cargo scooter of FIG. 45 showing the cargo hold disconnected from the scooter and showing two of four cargo hold wheels that the cargo hold is configured to be pushed or pulled on by the user;

FIG. 47 is a side view of the part of the electric cargo scooter of FIG. 45 showing the cargo hold disconnected from the scooter and showing two of four cargo hold wheels that the cargo hold is configured to be pushed or pulled on by the user;

FIG. 48 is an isometric view of part of the electric cargo scooter of FIG. 31 that is a platform-style hand truck comprising: two caster wheels and two fixed wheels (one of each type of wheel being shown), where the platform-style hand truck is removable from the scooter and is usable for transporting cargo separately from the scooter;

FIG. 49 is an isometric view of an electric cargo scooter that includes, among other things, two rear wheels and a solar panel over the cargo hold;

FIG. 50 is a side view of an electric cargo scooter of FIG. 49 where the solar panel raised to provide better access to the cargo hold;

FIG. 51 is an isometric view of an electric cargo scooter that includes, among other things, a solar canopy over the cargo scooter.

### DETAILED DESCRIPTION OF EXAMPLES OF EMBODIMENTS

This patent application describes, among other things, examples of certain embodiments, and certain aspects thereof. Other embodiments may differ from the particular examples described in detail herein. Various embodiments are or include: scooters, for example, that are ridden by people (e.g., for personal transportation), devices, apparatuses, machines, methods, or a combination thereof, for example, concerning or relating to such scooters. In various embodiments, for example, a scooter is human powered, for instance, being propelled by the rider, for instance, by pushing off the ground with a foot. In a number of embodiments, however, the scooter is electrically powered (e.g., instead or in addition to being human powered), for example, with an (e.g., onboard) battery, electric motor (e.g., ECM), and controller. In various embodiments, for instance, the battery is rechargeable. Various embodiments are unique, modular, versatile, portable, adaptable, or a combination thereof, as examples. Further, in a number of embodiments, the frame of the scooter includes interchangeable parts that can be optionally combined in multiple different useful configurations. Many embodiments can optionally be electrically powered, manually propelled by the rider, or both.

Some embodiments have a foldable frame (e.g., fully foldable) designed to facilitate multi-modal (or multimodal) travel. Some embodiments fit into passenger vehicles or fold small enough to be brought onto trains, buses, and ferries, as well as yachts and larger cruise ships, as examples. Further, certain embodiments pack into luggage (e.g., ordinary luggage that can be brought onto commercial flights), for instance. In a number of embodiments, the scooter's electrical system is powered by batteries, for example, which, in some embodiments, have been specifically designed for this purpose. Some embodiments are accepted by common air carriers, for example, as passenger luggage, for instance, as carry-on or “cabin baggage” or as checked bags, as examples.

The figures show components and assembly of several configurations. Additional configurations are beyond those shown. Various different three-wheeled configurations are shown in documents that are incorporated by reference. Other embodiments have two wheels. Various embodiments are shown. Different embodiments may be functionally the same or similar, or may have differences that may be illustrated. Certain embodiments include, for example, tandem (e.g., rear) wheels, which may be smaller than the front wheel in particular embodiments. Certain embodiments use wireless electric skateboard wheels, drive systems, or other parts, as examples. Various embodiments allow the user to roll the folded scooter on its wheels when in its folded position, for instance, so there is often no need to carry it. In some embodiments, for example, the user folds the frame, rotates the handlebars (e.g., 90 degrees from the deployed position), and then tips the folded scooter back a bit, to push it along upon its wheels, for example, like a wheelbarrow.

Further, some embodiments, include a configuration that provides for stowing the seat (e.g., when the rider wants to ride standing up), for example, that may be less expensive than other alternatives. In particular embodiments, for example, instead of folding the seat post, the user removes it from a receiver tube and stows it, for example, underneath, or alternatively above, the rear cargo rack. Certain embodiments include a seat post that can be pitch-adjusted, for example, without using tools. The figures include an exploded view of an example of this mechanism. Further, some embodiments include two hinges (e.g., within the frame). Even further, certain embodiments include a solar collector, for example, a canopy, for instance, that charges onboard batteries which power an electric version of the scooter. In various embodiments, one or more solar panels power the scooter while riding, charge the batteries while the scooter is parked, or both.

In various configurations, the scooter includes a seat accessory, for example, which may be adjustable in pitch (i.e., fore-aft), height, or both, for instance, by riders of different statures. This is illustrated for multiple embodiments. Various embodiments are functionally the same or similar. Particular embodiments, for example, include a strut adjuster, which: may be continuously adjustable; may not require tools for adjustment; may be similar to a turnbuckle; may facilitate quick adjustability of the scooter seat position; may control and restrain the position of a pitch-adjustable seat; or a combination thereof, as examples. Other embodiments include, for instance, a pitch-adjustable seat position that is adjustable into several discrete positions, for example, by use of a simple tool such as an Allen key, for instance, that is commonly used by cyclists.

Some configurations include a foldable frame, but in other configurations, the frame is not foldable (i.e., is rigid). Further, different configurations (e.g., foldable or rigid) have either two or three wheels, for example. Still further, different configurations (e.g., foldable or rigid) have different size (e.g., diameter) wheels, and some configurations have different size front wheels than rear wheels. In particular embodiments, for example, the front wheel is smaller in diameter, width, or both, when compared to the rear wheel or wheels. In other embodiments, however, the front wheel is larger in diameter, width, or both, when compared to the rear wheel or wheels. In some embodiments with two wheels, for instance, the front wheel has a larger diameter than the rear wheel. For instance, in particular embodiments, the front wheel has a 15-inch diameter and the rear wheel has a 12-inch diameter. In other embodiments, the front and rear wheels are the same diameter, for instance, 12 or 15 inches. Some three-wheeled embodiments have two wheels in the front. Other three-wheeled embodiments have one wheel in the front and two wheels in the rear.

Further, in some embodiments having three wheels, the two wheels tilt when the scooter is turned, for example, a “tilting trike”. Further, in certain embodiments with three wheels, the two wheels that are on the same end of the scooter are smaller than the single wheel on the opposite end of the scooter. In particular embodiments, for example, the front wheels each have an 11 inch diameter and the rear wheel has a 12- or 15-inch diameter, as examples. Different embodiments can either be electric (e.g., 15-inch powered rear wheel) or manual (e.g., 12-inch rear wheel).

In some embodiments, the scooter includes a frame, for example, that is foldable, for instance, without use of tools. In a number of embodiments, folding the frame automatically elevates the frame away from the ground during folding, for example, so that the folded assembly transitions to a compact, easily-transported state, for instance, in which the wheels are parallel or nearly parallel. Further, in a number of embodiments, the wheels remain on the ground when the scooter is in the folded position, and the frame is not at risk of damage due to contact with the ground while the user pushes, for instance, the folded scooter on its wheels. As a result, the user is not obliged to carry the folded assembly in order to transport it. Even further, in some embodiments, the user is able to utilize the folded assembly for porting cargo loads, for example, that are mounted on the assembly as the folded assembly is on the ground on its wheels. The “ground”, as used herein, may be the surface of a street or sidewalk, as examples.

Various embodiments include (e.g., one or more) folding joints, such as hinges or pivots (e.g., pivot points), for example, positioned or oriented within the frame in a manner that causes the frame to automatically move upwardly (e.g., away from the ground), while the joints are being actuated for collapsing the frame to its folded or minimized state. In some embodiments, for example, one or more of the joints may be positioned within the assembly such that their axis of rotation occurs at an angle less than 90 degrees perpendicular to the ground or deck, for instance, so that the deck or the entire assembly is automatically elevated away from the ground as the user collapses or folds the assembly. In a number of embodiments, as the assembly is moved into its folded position, the elevation of the frame occurs due to the rotation of the hinging or pivoting joints about an axis which is tilted (e.g., relative to horizontal). Further, while the assembly is in motion across the ground, in various embodiments, the wheels are at all times (e.g., normally or preferably) the only point of contact between the ground and the assembly. In some embodiments, as the joints are pivoted or rotated, elevation of the deck or frame occurs, for instance, due to change in axial distance between the deck and support points.

In a number of embodiments, a scooter includes a foldable scooter frame, for example, that can be deployed and folded without use of: tools, auxiliary wheels, or both. Further, in various embodiments, the scooter is usable for transportation of goods and cargo in both its fully deployed state and in its minimized, collapsed state. Still further, in some embodiments, the scooter has a modular design. Even further, in particular embodiments, the scooter includes interchangeable parts, for example, which can be assembled, disassembled, and reconfigured, for instance, by the user, for example, to create multiple configurations with different purposes, uses, or both. For example, one use is packing the assembly into luggage for commercial flights or other confined settings.

In a number of specific embodiments, for example, a foldable scooter includes a first wheel, a second wheel, and a frame, for instance, having at least one pivot point. Further, certain embodiments also include a third wheel. Still further, in various embodiments, the scooter is folded by rotation about the pivot point (i.e., on the frame), for example. Further still, in a number of embodiments, the scooter is configured to be ridden (e.g., on ground) by a user when the scooter is not folded, and when the scooter is ridden, the scooter is supported (e.g., on the ground) by the first wheel and the second wheel. Even further, in some embodiments, when the scooter is folded, the scooter is configured to be rolled (e.g., on the ground) by the user, for instance, on the first wheel, on the second wheel, or both, for example, for transportation of the scooter (i.e., when it is not being ridden). Moreover, in particular embodiments, when the scooter is folded, the scooter is configured to be rolled (e.g., on the ground) by the user, for instance, on the first wheel, on the second wheel, and on the third wheel, for example, for transportation of the scooter (i.e., when it is not being ridden). Examples include tadpole trike and tandem rear wheel configurations, for instance.

Further, in a number of embodiments, a scooter includes a first wheel, a second wheel, a frame, and a seat, for example, that a user can sit on when riding the scooter. Further still, certain embodiments also include a third wheel. In various embodiments, for example, a seat column supports the seat (e.g., from the frame), a strut adjuster, for instance, extends from the frame (e.g., to the seat column), or a combination thereof. In other embodiments, as another example, the strut adjuster extends to the seat. Still further, in a number of embodiments, the strut adjuster is configured to be adjusted by the user, for example, to adjust fore and aft position of the seat.

In some embodiments, for example, the strut adjuster is adjusted by altering the length the strut adjuster. Further, in some embodiments, the seat column is (e.g., also) adjustable, for example, to adjust the seat in a vertical direction. Further still, in particular embodiments, the seat column is a telescoping seat tube, for instance, configured to be adjusted by the user to adjust height of the seat. Still further, in various embodiments, the seat column pivots, for instance, where the seat column connects to the frame. Even further, in some embodiments, the strut adjuster pivots, for example, where the strut adjuster connects to the frame, where the strut adjuster connects to the seat column, or both. Such pivoting (e.g., of the seat column, strut adjuster, or both) may allow for adjustment of the seat, for example: in the fore and aft direction, with the strut adjuster, or both. Even further, in particular embodiments, the strut adjuster includes a central member or a member that the user rotates, for example, to adjust fore and aft position of the seat. In particular embodiments, the user does not need to rotate the central member, but rather, unlocks the central member and then moves the seat, and the central member rotates on its own as the user moves the seat. The user then locks the central member to maintain the desired seat position. Moreover, in certain embodiments, the strut adjuster is or includes a turnbuckle. Furthermore, in particular embodiments, the (e.g., central) member has right-handed threads, left handed threads, or both, for example, used to adjust length of the strut adjuster. Even further still, in certain embodiments, the strut adjuster is located on the scooter behind the seat or behind the seat column, for example, between the seat and the rear wheel(s) or between the seat column and the rear wheel(s). Examples are shown. Further, in various embodiments, the strut adjuster includes an adjustment locking mechanism (e.g., that locks to prevent adjustment of the strut adjuster, for instance, while the scooter is being ridden).

Further still, in some embodiments, the scooter includes a deck, and the user can stand on the deck when riding the scooter. Still further, in particular embodiments, when the scooter is being folded (i.e., from the not-folded position to the folded position, e.g., while the first wheel and the second wheel are on the ground, and in particular embodiments, the third wheel as well), the deck moves upwardly, for example, away from the ground. Even further, in certain embodiments, the pivot point is at an angle of less than 90 degrees from the deck. Even further still, in particular embodiments, the pivot point is at an angle of less than 90 degrees from the ground (i.e., when the scooter is not folded and the scooter is resting on the ground, for instance, on the first wheel, on the second wheel, and in some embodiments, the third wheel). Moreover, in some embodiments, the pivot point includes a hinge, a (e.g., pivot point) locking mechanism (e.g., that locks to prevent rotation around the pivot point, for instance, while the scooter is being ridden), or both. In particular embodiments, for example, the (e.g., pivot point) locking mechanism locks to prevent rotation around the pivot point when the scooter is folded. Moreover, in various embodiments, when the scooter is being folded (i.e., from the not-folded position to the folded position, e.g., while the first wheel and the second wheel, and in particular embodiments, the third wheel, are on the ground), the frame moves upwardly, for instance, away from the ground. In a number of embodiments, the pivot point or hinge includes a pin or axis, for example, that is nearly vertical (e.g., when the scooter is not folded and is resting on its wheels on horizontal ground). In some embodiments, for example, the pivot point, pin, or axis is at an angle of 60 to 89 degrees, 70 to 89 degrees, 75 to 89 degrees, 75 to 85 degrees, 77 to 83 degrees, 78 to 82 degrees, 75 to 80 degrees, 80 to 85 degrees, substantially 80 degrees, or 80 degrees, as examples, when measured from horizontal, the ground, the deck, or a combination thereof, as examples.

In various embodiments, the folded scooter is prevented from unfolding itself, for example, by a locking mechanism. Certain embodiments, for instance, include one or more latches. Examples are shown in some of the drawings. A tilting trike frame, for instance, has a front pivot that latches internally. Other embodiments have plunger-pin latches, for example, separate from the pivots or hinges, for instance, which temporarily conjoin the folded front fork to the deck, temporarily conjoin the folded rear fork to the deck, or both. An example of a rear fork latch is shown, exploded, in FIG. 2. Various embodiments include front and rear latches. Figures show examples of both a front fork latch and a rear fork latch.

In various embodiments, the scooter is configured to be folded and unfolded without using tools. As used herein, “configured” means designed specifically for the act described (e.g., in this case, “folded and unfolded without using tools”) in normal operation (e.g., by the user). Further, in some embodiments, the scooter includes a basket, for example, configured for transportation of cargo, for instance, when the scooter is being ridden. A basket may be a type of cargo hold. For example, the cargo may be a typical bag of groceries in a number of embodiments. In particular embodiments, the scooter is (e.g., also) configured so the (e.g., basket) can be used for transportation of the cargo when the scooter is folded, for example, and being rolled (e.g., on the ground) by the user, for instance, on the first wheel and on the second wheel. Further still, in a number of embodiments, when the scooter is folded, the first wheel is substantially parallel to the second wheel. As used herein, “substantially parallel” means parallel to within 15 degrees. Even further, in various embodiments, when the scooter is folded, the first wheel can be positioned or locked to be substantially parallel to the second wheel, or the scooter is configured so that the steering can be locked into a position so the first wheel is substantially parallel to the second wheel, or both.

In a number of embodiments, when the scooter is folded, or (alternatively) disassembled, the scooter will fit into a suitcase, for example, that is small enough to be taken on a commercial airline flight. This may include folding at more than one pivot point, for example. See, for instance, the drawings. Further, in particular embodiments, when the scooter is folded, the scooter will fit into luggage, for example, carry-on size luggage, for example, on a commercial airline flight, or non-carry-on size luggage, as another example. Still further, in some embodiments, the scooter is electrically powered. Even further, in particular embodiments, for example, the scooter includes an electric motor (e.g., that drives the first wheel), a battery (e.g., that powers the electric motor), a controller (e.g., that controls the electric motor), or a combination (e.g., all) thereof. Moreover, certain embodiments include multiple electric motors (e.g., that drive one or more wheels). Even further, in some embodiments, the first wheel is a rear wheel of the scooter. Further still, in some embodiments, the second wheel is a front wheel of the scooter. Even further still, in certain embodiments, the first wheel and the second wheel have unequal diameters. Examples are shown on the drawings, described herein, or both.

Moreover, in particular embodiments, the scooter (e.g., further) includes a third wheel. Further, in various such embodiments, when the scooter is being ridden, the scooter is supported (e.g., on the ground) by the first wheel, the second wheel, and the third wheel. Still further, in certain embodiments, the third wheel is a front wheel of the scooter. In other embodiments, however, the third wheel is a rear wheel of the scooter. Even further, in particular embodiments, the third wheel and the second wheel of the scooter tilt, for example, when the scooter turns a corner, for instance, in certain embodiments where the third wheel and the second wheel are front wheels of the scooter. Further still, in particular embodiments, the first wheel and the third wheel are tandem (e.g., rear) wheels of the scooter. Even further still, in some embodiments, the first wheel and the third wheel, as examples, have a common diameter, are each smaller in diameter than the second wheel, or both. Moreover, in some embodiments, the first wheel and the third wheel each include an electric motor. For instance, in particular embodiments, the scooter includes a first electric motor that drives the first wheel and a second electric motor that drives the third wheel. Some embodiments further include a battery, for example, that powers the first electric motor and the second electric motor, a controller, for instance, that controls the first electric motor and the second electric motor, or both.

Various embodiments provide for rolling the scooter on three wheels. In particular embodiments, for instance, this can be done in both the tandem wheels configuration and also the trike configuration. In some embodiments, a trike can be transformed from its deployed state to a stowed position wherein it can be rolled on three wheels, for example, in its fully minimized state. In some embodiments, after the trike wheels have been relocated from deployed (riding) position, the handlebar post is folded (stowed) as well, for example, creating a very compact configuration that may be stashed underneath a desk, for instance. Further, some embodiments include parts and mechanisms that allow the user to transform the trike from a rideable, deployed state into the folded state that can be rolled on the ground for easy transport. In certain embodiments, for example, the user accomplishes this transformation without the use of tools. In particular embodiments, for instance, The two front (e.g., 11-inch diameter) trike wheels have pushbutton quick-release axles. An example is a type already in use on wheelchairs. In some embodiments, the axles are installed on the trike. In certain embodiments, the user pushes a spring-loaded pushbutton on the (outboard) end of each axle to release the axle from the trike assembly and remove the wheel from the assembly. In particular embodiments, the user then relocates (e.g., both) of the two front trike wheels to their stowed position, for instance, using the same pushbutton axles to install them in their stowed orientation.

In various embodiments, the scooter further includes handlebars, for example, that rotate to steer (e.g., at least) one (e.g., the second) wheel. Moreover, in a number of embodiments, the scooter further includes at least one brake, for example, that the user applies to slow rotation of at least one (e.g., the second) wheel. An example is a hydraulically- or cable-operated disc brake, for example, operated by a hand lever on the handlebars.

Various embodiments of (e.g., electric) scooter models (e.g., frames thereof) are convertible (e.g., to or from) various cargo-carrying styles. An example has a long wheelbase with a long cargo hold (e.g., cargo box), for example, with a load capacity of approximately 150 pounds of cargo, 6 (or more) standard grocery bags, or both. Further, “approximately”, as used herein, means to within plus or minus 25 percent. Another example has a shorter wheelbase with short cargo hold (e.g., cargo box), for instance, with a load capacity of approximately 100 pounds of cargo, 4-5 standard grocery bags, or both. Further, yet another example has a short frame (“Generation 5”) with an (e.g., optional) cargo basket (e.g., rather than a cargo box), for instance, foldable to the smallest (minimum) collapsed size.

In a number of embodiments, the cargo scooter converts, or is convertible, for example, without tools, to and/or from: a deployed state, for example, rideable with or without cargo, and a semi-stowed state, for instance, converted into a cart (e.g., a shopping cart). In this context, a cart is pushed or pulled by the user while the user walks on the ground whereas a scooter is usually (or is configured to be) ridden by the user. In various embodiments, the ability to be converted into a cart reduces or eliminates or minimizes risk of theft, for example, since there is no need to leave the scooter unattended (e.g., locked up in public areas), for instance, while the user is in a retail environment. Rather, in various embodiments, the minimized or stowed scooter can be conveniently wheeled indoors and brought into many retail settings.

Further, in various cargo scooter configurations, in the fully deployed or rideable state, the scooter may have (e.g., two) auxiliary wheels, for instance, approximately 4-inch diameter wheels, or in some embodiments, rescue wheels. In various embodiments, auxiliary wheels have multiple functions, can be stowed and deployed without use of tools, or both, as examples. Still further, in particular embodiments, the auxiliary wheels have three functional positions, for example. In some embodiments, for example, in a deployed position, rescue wheels assist the rider in case of loss of balance, for instance, during riding, for example, by preventing the edges or corners of the cargo hold or box from contacting or dragging on the ground. Even further, rescue wheels may (e.g., momentarily) support the cargo hold or box when the scooter is tilted or banked, for instance, while traveling across a steeply inclined or declined roadway. Further still, in various embodiments, in a stowed position, rescue wheels will not contact the ground during riding. Even further still, in certain embodiments, the rescue function is available to be deployed, for example, without use of tools. Moreover, various embodiments include a cart mode in which auxiliary or rescue wheels are deployed (e.g., latched) into their lowest position, for example, while in contact with the ground, for instance, to permit quick and simple conversion of the scooter from its rideable state into a (e.g., shopping) cart.

Different embodiments of cargo scooters can utilize different styles of cargo holds or cargo boxes. In particular embodiments, the cargo hold or cargo box, for example, accepts and stow the rear half or part of the deployed cargo scooter, for example, which, in some embodiments, is folded or detached (or both) from the front half or part of the cargo scooter in various models. In certain embodiments, this transforms the deployed scooter from its rideable state into its cart mode, for example, so that the user can (e.g., comfortably and conveniently) keep the complete scooter with them, for example, while in a retail environment.

Various embodiments include various cargo hold configurations. Examples include rigid cargo box designs. One example is a short rigid cargo box, for example, with an (e.g., optional) hinged cover. In particular embodiments, this cargo box requires tools for disassembly and removal from the scooter frame, for example, for storage and shipping. Certain embodiments include a load capacity of approximately 100 pounds of cargo, 4-5 standard grocery bags, or both. Another example is a long rigid cargo box, for instance, with an (e.g., optional) solar panel cover. Again, in particular embodiments, this cargo box requires tools for disassembly and removal from the scooter frame, for example, for storage and shipping. Certain embodiments have a load capacity of approximately 150 pounds of cargo, 6 or more standard grocery bags, or both. Other embodiments include foldable box designs. Some embodiments have removable side panels, for example, not requiring use of tools. Further, in certain embodiments, removing one side panel facilitates stowing the folded rear end or part of the cargo scooter inside the cargo box. Still further, in particular embodiments, removing 2 side panels facilitates full collapse of the cargo box to a flat folded state, which, in some embodiments, is also completely removable from the scooter frame, for instance, without use of tools. Even further, an additional style of foldable cargo box has a removable rear panel, for instance, which stows and deploys without the use of tools. In particular embodiments, for example, this cargo box also folds to a flat state, but in certain embodiments, requires use of tools to be removed from the scooter frame.

In a number of embodiments of a cargo scooter, or a non-cargo scooter, the scooter includes a suspended seatpost, for example, which is quick-adjustable, continuously adjustable, or both, for instance, by the user, for example, without requiring use of tools. Further, in various embodiments, adjustability of the seatpost pitch, of the seat height, or both, is continuous. Still further, in various embodiments, the scooter can be disassembled, for instance, for storage and/or shipping, and in particular embodiments, can pack into a suitcase or box. In some embodiments, cargo scooter models pack into larger narrow and/or flat-pack boxes, for example, optimal for shipping. In various embodiments, a solar panel charges the scooter batteries while the scooter is parked in the sun, while riding, or both.

In some embodiments, the scooter includes a cargo hold (e.g., cargo box), the scooter includes (e.g., two) auxiliary wheels, or both. For example, in particular embodiments, the auxiliary wheels each have multiple functions, can be stowed and deployed (e.g., into three functional positions), or a combination thereof. Further, in some embodiments, the auxiliary wheels can (e.g., each) be deployed into a position as rescue wheels, for example, that assist the rider in case of loss of balance, for instance, while riding the scooter. Still further, in various embodiments, the auxiliary wheels can (e.g., each) be deployed into a position in which the auxiliary wheels contact the ground, for example, and the scooter is configured to be used as a (e.g., shopping) cart. Moreover, in various embodiments, the scooter converts, is convertible, or is configured to convert, between a deployed state (e.g., that is rideable), and a semi-stowed state (e.g., in which the scooter is useable as a shopping cart, for instance, in a retail environment). Even further, in some embodiments, the scooter converts without tools between the deployed state and the semi-stowed state. Even further still, in certain embodiments, the scooter is configured to carry cargo in the deployed state, the semi-stowed state, or both.

Various examples of embodiments include a scooter comprising a first wheel, a second wheel, and a frame. Further, in some such embodiments, the scooter further includes (e.g., two) auxiliary wheels, for instance, that each have multiple functions, that can each be stowed and deployed into various (e.g., three) functional positions, or both. Further still, in some embodiments, the auxiliary wheels can each be deployed into a position as rescue wheels, for example, that assist the rider in case of loss of balance, for instance, while riding. In particular embodiments, the auxiliary wheels can be deployed to contact the ground in which the scooter is configured to be used as a (e.g., shopping) cart. Even further, in various embodiments, the scooter converts, or is convertible, between a deployed state that is rideable; and a semi-stowed state in which the scooter is useable as a (e.g., shopping) cart, for example, in a retail environment. Even further still, another example is a scooter having a first wheel, a second wheel, a frame, and a cargo hold or cargo box, wherein the cargo box, for example, accepts and stows a rear part of the scooter, for example, which is folded and detached from a front part of the scooter, for instance, to transform the scooter from a deployed rideable state into a configuration to be used as a shopping cart, for example, so that a user can keep the scooter with the user while in a retail environment.

In certain embodiments, the cargo box has a load capacity, for example, of approximately 150 pounds of cargo. Further, in particular embodiments, the cargo box has a load capacity of at least 6 standard grocery bags or of approximately 6 standard grocery bags, as examples. In other embodiments, the cargo box has a load capacity of approximately 100 pounds of cargo, at least 4 standard grocery bags, approximately 4 standard grocery bags, approximately 5 standard grocery bags, or a combination thereof. Further still, in particular embodiments, the scooter has a cargo basket. Even further still, in certain embodiments, the cargo basket is foldable, for example, into a collapsed position. Moreover, in some embodiments, the scooter is modular. Further still, in particular embodiments, certain major assemblies of the scooter can be replaced to obtain a scooter with different characteristics.

In particular embodiments, the auxiliary wheels each have a diameter of approximately 4 inches. Further, in some embodiments, the auxiliary wheels can be stowed and deployed, for example, without the use of tools. Still further, in certain embodiments, the auxiliary wheels can each be deployed (e.g., into a position) to prevent edges or corners of the cargo hold (e.g., cargo box), for example, from contacting, or dragging on, the ground. Even further, in particular embodiments, the auxiliary wheels (e.g., momentarily) support the cargo box, for example, when the scooter is tilted or banked, while traveling across a steeply inclined or declined roadway, or a combination thereof, for example. In various embodiments, however, the auxiliary wheels can (e.g., each) be deployed into a position in which the auxiliary wheels will not contact the ground during riding. Even further still, in some embodiments, the cargo hold or cargo box accepts, stows, or both, a rear part of the scooter, for example, which is folded, detached, or both, from a front part of the scooter, for instance, to transform the scooter from a deployed or rideable state (or both), for example, into a configuration to be used as a (e.g., shopping) cart, for instance, so that a user can (e.g., comfortably, conveniently, or both) keep the scooter with the user, for example, while in a retail environment.

Particular embodiments include wireless controls, for example, wireless speed control. Certain embodiments, for example, include a custom-designed local wireless network, for instance, that is onboard the scooter. Further, various embodiments provide for, and permit, the rider (e.g., exclusively) to control speed, for example, with a throttle, an electronic (e.g., rear) brake, or both. In particular embodiments, hardware includes an electronic circuit board or transmitter, for example, mounted on the (e.g., right) handlebar, for instance, that is wired to a twist throttle, that the rider can rotate (e.g., 60 degrees of circumference) about the handlebar, for example, like on a motorcycle. Still further, various embodiments include a brake lever that has an on-off sensor in it, for instance, wired to the transmitter. Even further, in a number of embodiments, the signal transmits wirelessly to a further circuit or receiver, for example, that is mounted proximate the rear wheel. In certain embodiments shown, for example, the receiver is mounted on a tall, triangular-shaped transparent plastic support underneath the rear rack that the battery is sitting on top of, over the rear wheel. Even further still, in various embodiments, the receiver is wired to the motor controller (e.g., which may be enclosed under the battery). This is an example of how the rider can signal and accelerate the motor. Further still, in particular embodiments, the brake signal is (e.g., also) wirelessly transmitted, for instance, in this same manner.

Still further, in a number of embodiments, the scooter includes a custom or customizable (e.g., suspended) seatpost. Even further, some embodiments include tool-free or quick-adjustable (or both) seat height adjustability. Various embodiments provide a unique combination to bicycles and scooters. Particular embodiments include, for example, quick height adjustability together with suspension of the seat, for instance, for a more comfortable ride. Even further still, some embodiments are adjusted by pulling or pushing on a lever that actuates a gas spring, for example, similar to actuation of existing height-adjustable office chairs. Certain embodiments, however, combine this (e.g., in a single assembly) together with custom (and/or customizable) seatpost suspension to increase ride comfort. Further still, some embodiments include a height-adjustable handlebar. The figures show some examples.

A number of embodiments include (e.g., tool-free) quick deployment and conversion to cart mode. In particular embodiments of cargo scooter models, for example, the rear part or half of the scooter folds and detaches from the front (e.g., cargo) end of the scooter, for instance, without requiring tools. Further, some embodiments provide for quick conversion, for example, from a deployed or rideable state to a stowed or semi-stowed position. Still further, various embodiments provide emphasis on ability to quick-deploy and quick-stow, to and from cart mode. Even further, in a number of embodiments, this makes the scooter multi-functional. Moreover, various embodiments quick-detach and re-attach, for example, to make the multiple functions of the scooter practical and convenient for use by the user. In some embodiments, a cargo scooter design or frame, for example, has (e.g., interchangeable) parts that can (e.g., also) be used with an (e.g., existing) e-bike. In particular embodiments for example, the front half of the cargo frame has two separable pieces. In certain embodiments, for example, one of these pieces is taller at the front, near the front wheel, and certain embodiments use that for the cargo e-bike (e.g., but not for the cargo scooter). Other embodiments may differ.

Various embodiments include various different designs. One such design is a cargo scooter that has a removable cargo hold, for example, which may look like a rectangular bucket, at the front end. In some embodiments of this design, this bucket structure can be used both on the scooter and off of it, for instance, in particular embodiments, as both a shopping cart and a hand truck. Further, some embodiments include a linkage, for example, that conjoins a front-loaded cargo structure with an (e.g., existing, electric, or both) bicycle. In certain embodiments, this adds cargo capacity to a (e.g., very powerful electric) bike. The shopping cart feature is not available with all embodiments of this design, but the cargo bucket may be the same as on the cargo scooter, and it may be similarly removable from the cargo bicycle, and may be be used as a hand truck, as a shopping basket, or both in particular embodiments. Although this is not necessarily the same as a shopping cart, it may allow the user to use the cargo hold (e.g., bucket) in a retail setting, for example, for collecting groceries or other goods, because it can roll on its own (e.g., small) wheels. In some embodiments, this may be the same as or similar to a cargo hold that is removable from a cargo scooter. Even further, certain embodiments include “tandem drive” scooters, for example, which may be streamlined, have various suspension, or a combination thereof.

Captions on a number of the figures describe examples of embodiments which may be illustrated. Some embodiments include, for example, convertibility to and from “cart mode”, for instance, via separation of the frame into 2 halves, and stowing the folded rear end, for example, in the cargo hold, for instance, to create the shopping cart. In certain embodiments, the cargo hold can be one of multiple styles, which may be removable from the cargo frame for use as a (e.g., small) platfom-style hand truck, as a shopping trolley, or both. Certain embodiments include, for example, four wheels attached (e.g., screwed) onto the bottom of the cargo hold. Further, some embodiments use telescoping handles, for example, similar to handles used on suitcases. In particular embodiments, the cargo hold can be installed and un-installed on the cargo frame (e.g., by the user), without tools, and this assembly itself can be conjoined together with the cargo scooter and, alternatively, in certain embodiments, with a (e.g., specific, high-torque, or both) electric bicycle (e.g., brand name “FLX”). Various embodiments have significant versatility in the cargo-carrying accessory. Further still, various designs are multifunctional and convertible into other useful tools. Examples include the hand truck and convertibility to hand truck and electric cargo bike. Different embodiments include, or can be used as: an electric cargo scooter, an electric cargo bicycle, a foldable electric commuter scooter, a foldable human-propelled exercise scooter, a shopping cart, and a hand truck.

An example of an embodiment is a (e.g., front-loading) cargo accessory that is usable and interchangeable on both a cargo scooter & a cargo bike. Further, certain embodiments include (e.g., various styles of) a multi-functional cargo-carrying accessory that is usable both on & off of a cargo scooter, a cargo bicycle, or both. Examples of multi-functionality include, in particular embodiments: a 3-wheeled shopping cart, a 4-wheeled shopping trolley, and a platform-style hand truck. Still further, some embodiments include a (e.g., improved, quick release, or both) mechanism for transforming between a scooter and a shopping cart, for example. Even further, various embodiments include a (e.g., quick-release, quick installed, or both) suspension seat post. Various (e.g., essential) mechanical parts are shown on the drawings. The drawing captions contain further information. Some embodiments include, for instance, a (e.g., removable) cam-actuated kingpin. In particular embodiments, for example, this fastens the cargo scooter front half (e.g., at the tow bar) to the cargo scooter rear half (e.g., at the tow hook that seats into the tow bar). Further still, in some embodiments, the kingpin allows the user to separate the cargo scooter (e.g., without use of tools) into two halves. In particular embodiments, for example, the rear half folds up and stows in the cargo hold area in the cart. In some embodiments, (e.g., of the tow bar & tow hook) a single kingpin is used, wherein, in other embodiments, two kingpins are used.

In certain embodiments, the cargo hold is removable (e.g., by the user, without tools, or both) from the scooter frame and is usable for transporting cargo separately from the scooter, for example, via wheels onto the bottom of the cargo hold. In particular embodiments, for instance, the bottom of the cargo hold includes two (e.g., small) caster wheels and two (e.g., small) fixed-direction wheels. In this example, these wheels transform the cargo hold into a (e.g., small) hand truck, which is usable as a (e.g., small) rollable platform, and, in some embodiments, also as a rollable crate. In such embodiment, the cargo hold is “convertible” between these two functions. Further, in some embodiments, the hand truck, crate, or both, are mountable on a frame that is conjoinable (e.g., at the user's option) onto a cargo bicycle. In various embodiments, the cargo hold is “interchangeable”, because it is mountable (e.g., by the user, without tools, or both) on both an electric cargo scooter and an electric bicycle. Still further, in particular embodiments, the scooter converts into a shopping cart, but the cargo bike assembly does not. In some embodiments, however, the cargo hold, hand truck, or platform truck (or a combination thereof) is usable on both the scooter and the bicycle. Even further, in some embodiments, the (e.g., convertible) cargo hold is an interchangeable accessory to both bike and scooter. In other embodiments, however, for instance, an illustrated 3-wheeled cart, is not an interchangeable accessory to both bike and scooter.

In various embodiments, a scooter or bike accessory is a collapsible & convertible cargo hold. Further, in some embodiments, it holds 3 bags of groceries, folds up, or both, as examples. Still further, in particular embodiments, a single-kingpin joint is used on the scooter, the cargo hold is interchangeable with an electric bike and a cargo scooter, or both. Even further, in some embodiments, the cargo hold can be converted (e.g., by the user, without tools, or both) into a platform hand truck. Even further still, in certain embodiments, the scooter (e.g., the entire scooter excluding the hand truck) can be packed into a suitcase and ported on that hand truck, through an airport, for instance. Moreover, in particular embodiments, the scooter will disassemble sufficiently to be packed into a 24″×24″×44″ suitcase, for instance. This is another way in which particular embodiments are convertible. Furthermore, in some embodiments, the cargo hold is configured (e.g., is big enough) to carry the (e.g., folded) rear half of the cargo scooter. Further still, in certain embodiments, the cargo hold is specifically designed to do that. In other embodiments, the cargo hold carries goods, but is not designed to carry the scooter or bike upon which it is installed and used. In particular embodiments, however, the cargo hold carries the vehicle (e.g., scooter), as well as the vehicle carrying the cargo accessory.

In a number of embodiments, a scooter includes a cargo hold, for example, that is configured to be used to carry cargo on the scooter. Certain examples are shown. Further, in some embodiments, the cargo hold is (e.g., also) configured to be disconnected from the scooter, connected to a bicycle, and used to carry cargo on the bicycle. The bicycle may be an e-bike, for example. Still further, various embodiments are or include such a cargo hold (e.g., that is so configured). Even further, in some embodiments, the cargo hold is (e.g., also) configured to be: disconnected from the scooter, pushed by the user in front of the user (e.g., when the user is walking), and used, for instance, as a shopping cart, for example, while the user is shopping in a store. Further still, in particular embodiments, the cargo hold or shopping cart rolls on three wheels while the user is shopping in the store. In certain embodiments, (e.g., smaller) rear wheels of the shopping cart are included, deploy, or both, for this purpose, for example.

In various embodiments, the scooter includes a front wheel. Further, in a number of embodiments, the front wheel of the scooter also serves as a front wheel of the shopping cart, for example, while the user is shopping in the store. Still further, in some embodiments, the front wheel of the scooter also serves as a front wheel of the bicycle, for example, while the cargo hold is connected to the bicycle. Even further, in certain embodiments, the front wheel of the scooter replaces the (e.g., original) front wheel of the bicycle while the cargo hold is connected to the bicycle. Further still, in a number of embodiments, the cargo hold is mounted on the bicycle in front of the user when the cargo hold is connected to the bicycle and the user is riding the bicycle. Even further still, in some embodiments, the cargo hold is mounted on the bicycle in front of handlebars of the bicycle when the cargo hold is connected to the bicycle. Moreover, in various embodiments, the cargo hold is mounted on the bicycle behind the front wheel of the scooter when the cargo hold is connected to the bicycle. Furthermore, in particular embodiments, the front wheel of the scooter is turned by the user by turning handlebars of the bicycle while the cargo hold is connected to the bicycle (e.g., when the front wheel of the scooter is serving as the front wheel of the bicycle).

In a number of embodiments of a cargo hold that is configured to be used to carry cargo on a scooter, the cargo hold is also configured to be disconnected from the scooter, pushed by the user (e.g., in front of the user, for example, when the user is walking), and used as a shopping cart, for example, while the user is shopping in a store. Further, in various embodiments, the cargo hold is mounted on the scooter in front of the user when the user is riding on the scooter. Even further, in some embodiments, the cargo hold is configured to carry the scooter (e.g., excluding the cargo hold) when the cargo hold is being pushed by the user (e.g., in front of the user, when the user is walking, or both). Still further, in particular embodiments, the cargo hold includes (e.g., four) cargo hold wheels and the cargo hold is configured to be disconnected from the scooter and pushed or pulled on the (e.g., four) cargo hold wheels, for example, by the user, for instance, when the user is walking. Even further still, in some embodiments, the cargo hold is configured to be used by the user as a trolley, as a hand truck, or both, as examples, on the (e.g., four) cargo hold wheels. Still further, in some embodiments (e.g., of a scooter or cargo hold), the cargo hold includes a telescoping handle, a pivoting handle, or both (e.g., a handle that telescopes and pivots), for example, that the user uses to push or pull the cargo hold, for instance, when the cargo hold is disconnected from the scooter and the user is walking.

Further, in some embodiments, the cargo hold connects to, and separates from, part of the scooter with a kingpin. Various embodiments of a scooter include a kingpin that performs this function. Still further, in certain embodiments, the kingpin is cam actuated (e.g., a cam-actuated kingpin). In some embodiments, the scooter or cargo hold includes two kingpins (e.g., for this feature), but in other embodiments, the scooter or cargo hold includes only one kingpin. Certain examples are shown in the figures. Even further, in various embodiments, the scooter includes a first wheel, a second wheel, and a frame. These wheels may be the front wheel and the rear wheel of the scooter, for example. Even further still, in some embodiments, the scooter includes a seat, for example, that a user can sit on when riding the scooter. Moreover, in certain embodiments, the scooter includes a seat column, for instance, that supports the seat from the frame, a strut adjuster, for example, that extends from the frame to the seat column, or both. Furthermore, in particular embodiments, the strut adjuster is configured to be adjusted by the user, for instance, to adjust fore and aft position of the seat.

In various embodiments, the scooter (e.g., that has a cargo hold) has an electric motor, for example, that drives the scooter when the user is riding the scooter. Further, in some embodiments, the cargo hold is configured to carry part of the scooter, for example, including the electric motor, for instance, when the cargo hold is being pushed by the user while the user is walking. Further still, in a number of embodiments, the scooter includes a traction battery, for example, that powers the electric motor, for instance, that drives the scooter when the user is riding the scooter. Even further, in some embodiments, the cargo hold is configured to carry part of the scooter, including the traction battery, for instance, when the cargo hold is being pushed by the user, for example, while the user is walking. Still further, in certain embodiments, the scooter has (e.g., includes) a solar panel, for instance, that charges the traction battery. Even further still, in a number of embodiments, the electric motor drives (e.g., at least one) rear wheel of the scooter. Moreover, in various embodiments, the cargo hold is configured to be disconnected from the scooter by the user without using tools. Furthermore, in some embodiments, the scooter is collapsible, the scooter is configured to disassemble sufficiently to be packed into a 24″×24″×44″ suitcase, or both.

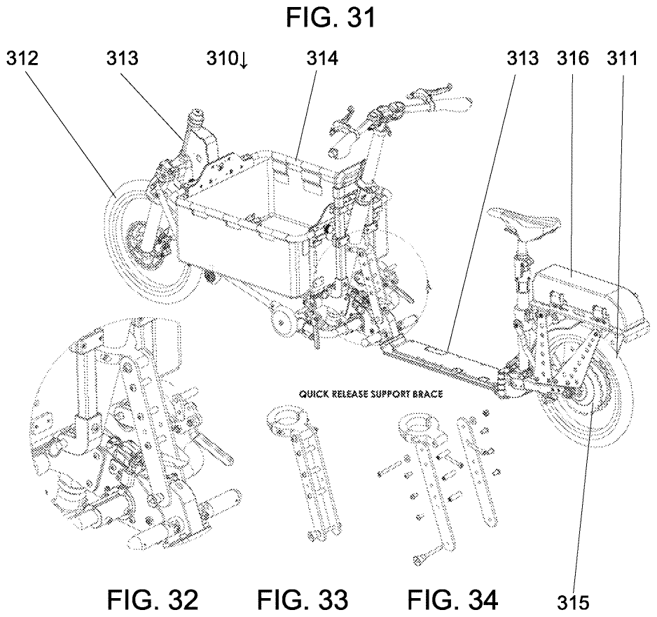

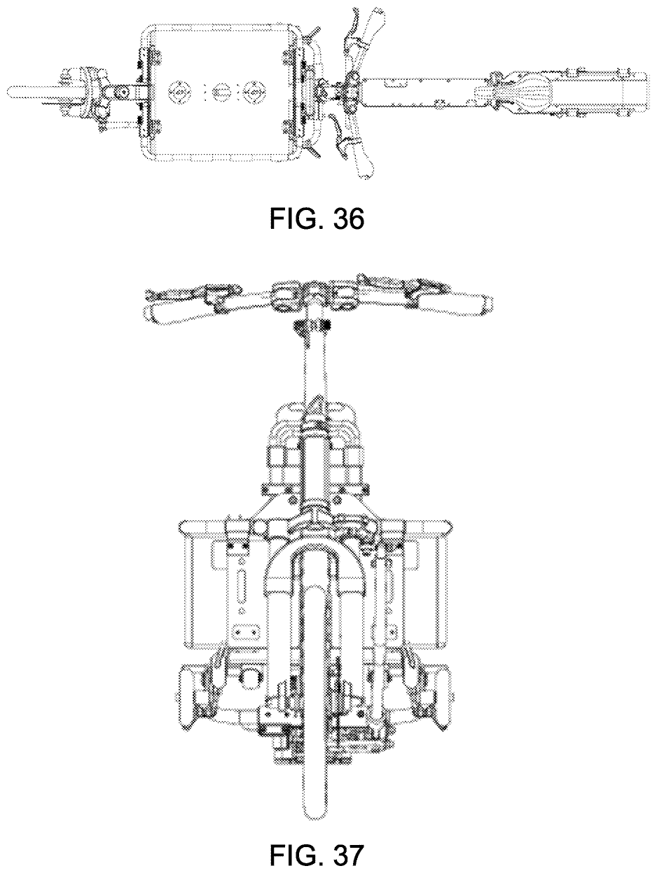

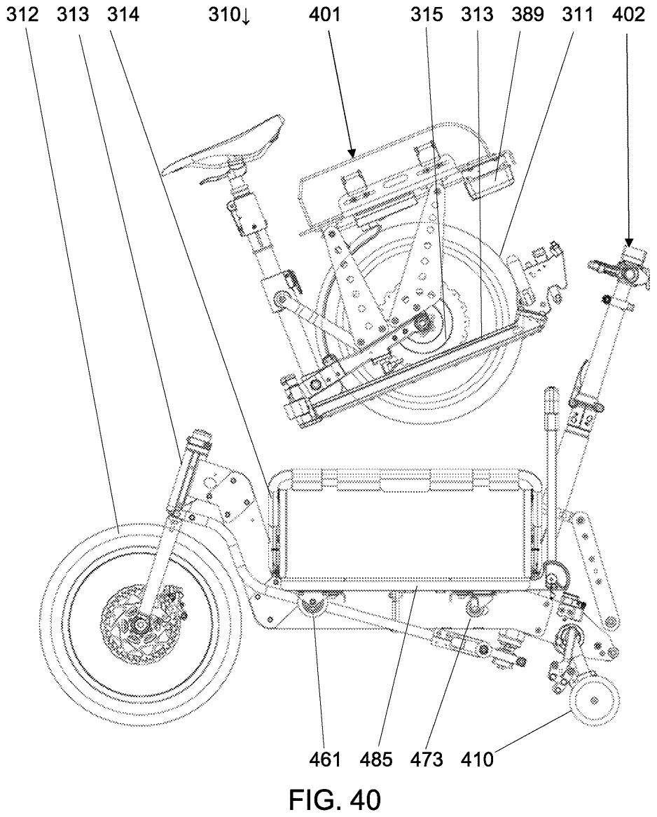

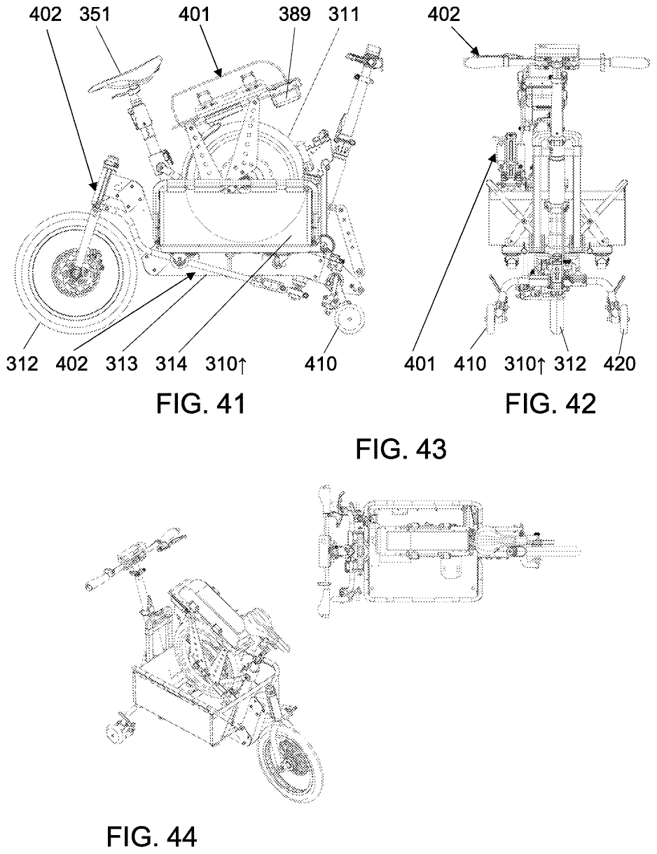

Referring to the drawings, various examples of scooters are shown. For example, FIGS. 31-44 show scooter 310 that includes first wheel 311, second wheel 312, frame 313, and cargo hold 314. These reference numbers are shown in FIGS. 31 & 40. As shown in FIGS. 41-44, cargo hold 314 accepts and stows rear part 401 of scooter 310; which is detached from front part 402 of scooter 310. These reference numbers are shown in FIG. 40. In this embodiment, rear part 401 of scooter 310 is detached from front part 402 of scooter 310, to transform scooter 310 from a deployed rideable state (e.g., shown in FIGS. 31 & 35-37) into a configuration to be used as a (e.g., shopping) cart (e.g., shown in FIGS. 41-44), for instance, so that a user can keep scooter 310 with the user, for instance, while in a retail environment. As shown in FIGS. 41 & 42, in the embodiment illustrated, scooter 310 includes two auxiliary wheels 410 & 420 that are each shown deployed into a position in which these auxiliary wheels contact the ground, and thereby convert scooter 310 into the configuration shown (i.e. in FIGS. 41-44) to be used as the (e.g., shopping) cart. As shown in FIG. 42, for example, in this embodiment, the (e.g., shopping) cart (i.e. scooter 310 in the configuration shown in FIGS. 41-44) rolls on at least three wheels (i.e. wheels 312, 410, & 420, for example, while the scooter is in the configuration to be used as the shopping cart). Further, in the embodiment depicted, cargo hold 314 is configured to carry rear part 401 of scooter 310, and when scooter 310 is in the configuration to be used as the shopping cart (i.e. scooter 310 in the configuration shown in FIGS. 41-44), the shopping cart is pushed by the user in front of the user, for example, while the user is walking.

In various embodiments, one of the first wheel and the second wheel is a front wheel of the scooter. In the embodiment shown, for example, in FIG. 31, second wheel 312 is the front wheel of scooter 310. Further, in the embodiment illustrated, the front wheel of the scooter (i.e. second wheel 312, as shown) also serves as a front wheel of the configuration used as the (e.g., shopping) cart (e.g., while the user is shopping in the retail environment), for instance, as shown in FIGS. 41-44. Still further, in the embodiment shown, rear part 401 of scooter 310 is folded before being stowed in front part 402 (e.g., cargo hold 314) of scooter 310. For instance, the rear part of the scooter is shown unfolded in FIGS. 31-38 and is shown folded in FIGS. 39-44.

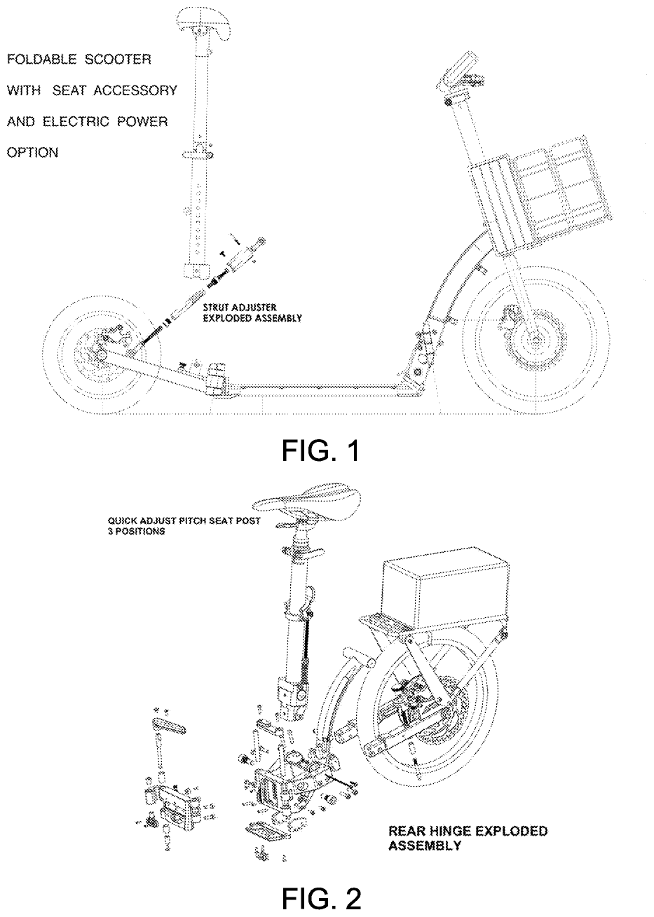

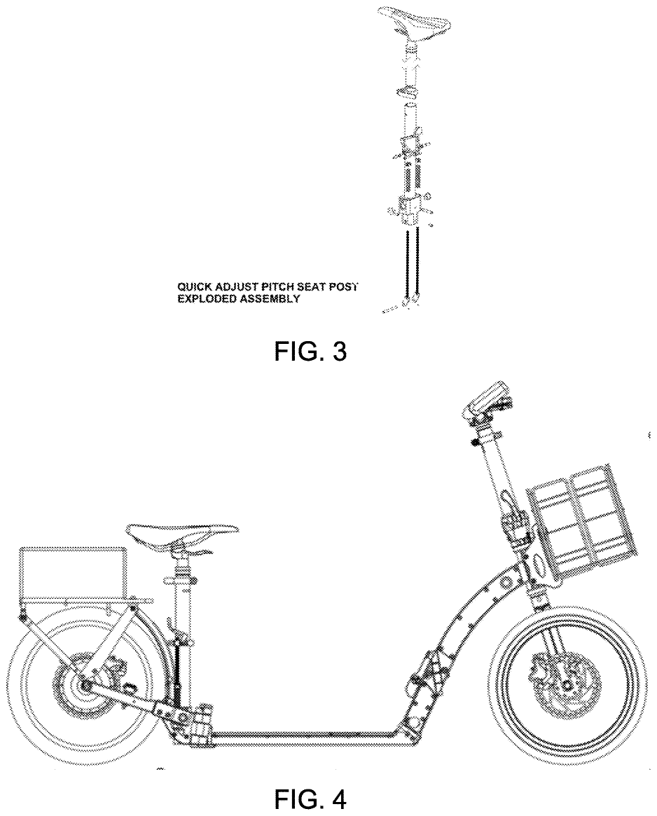

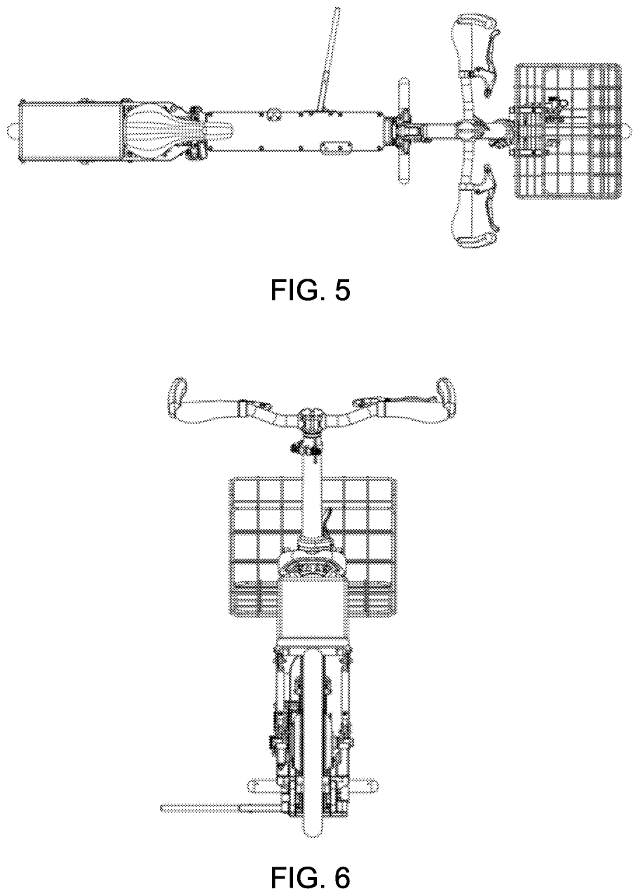

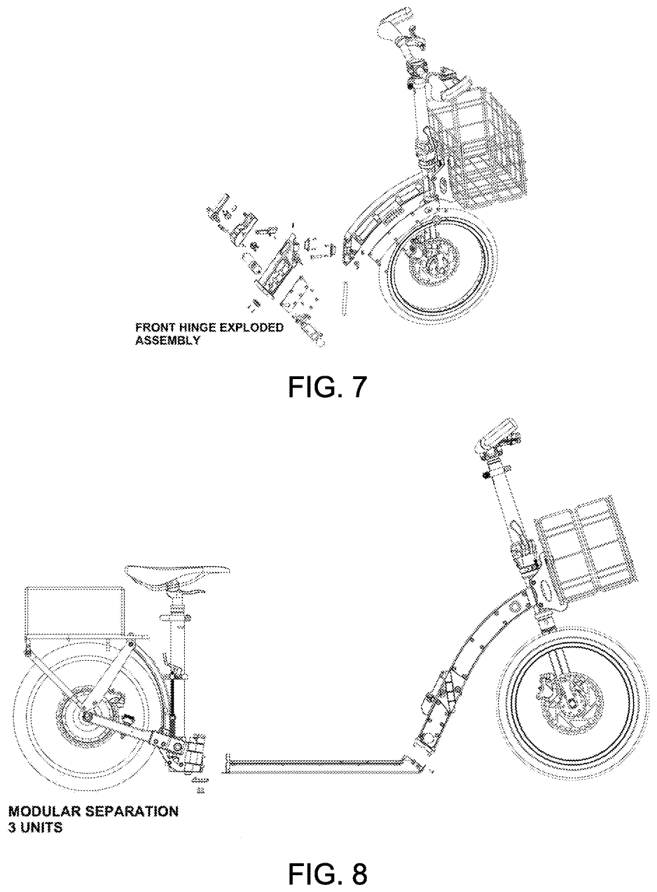

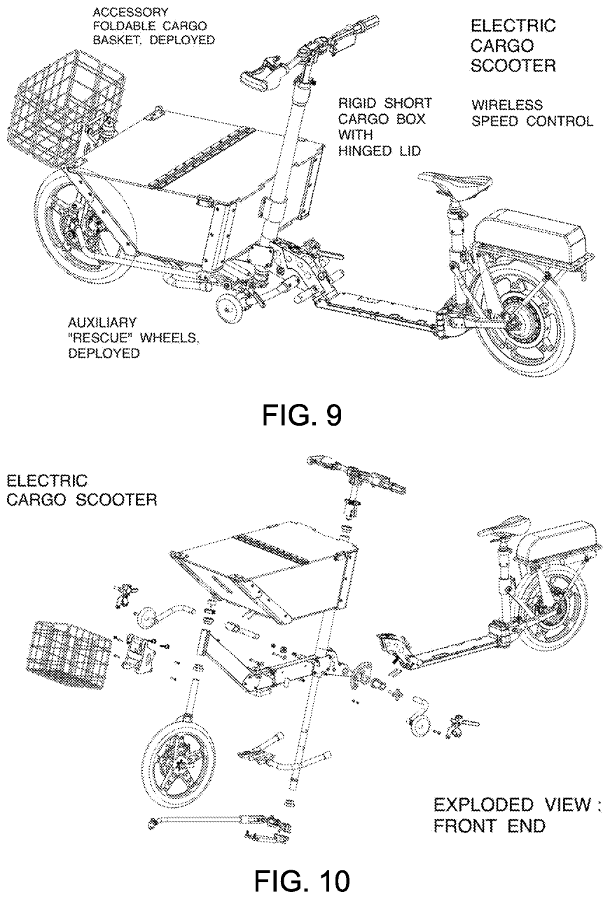

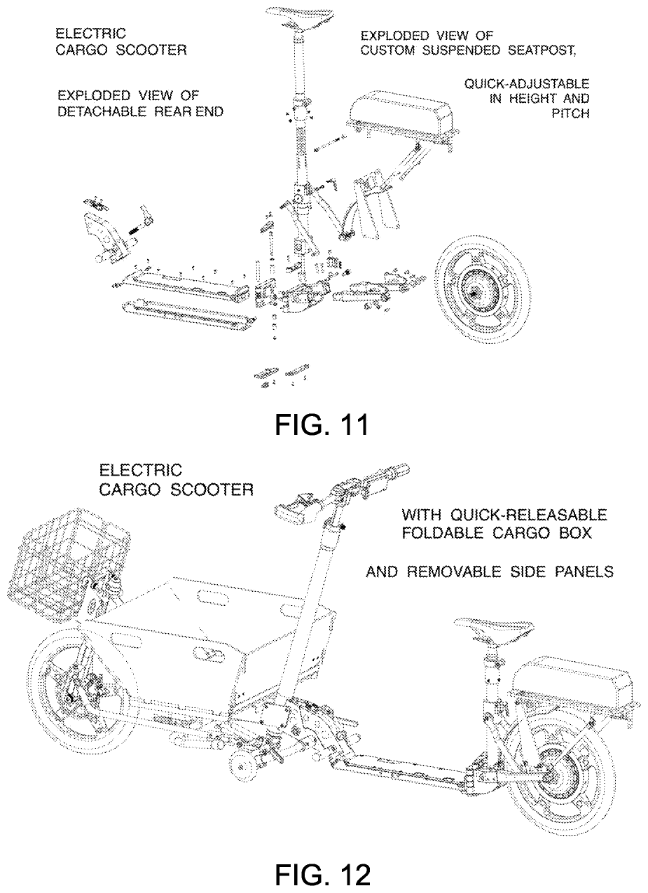

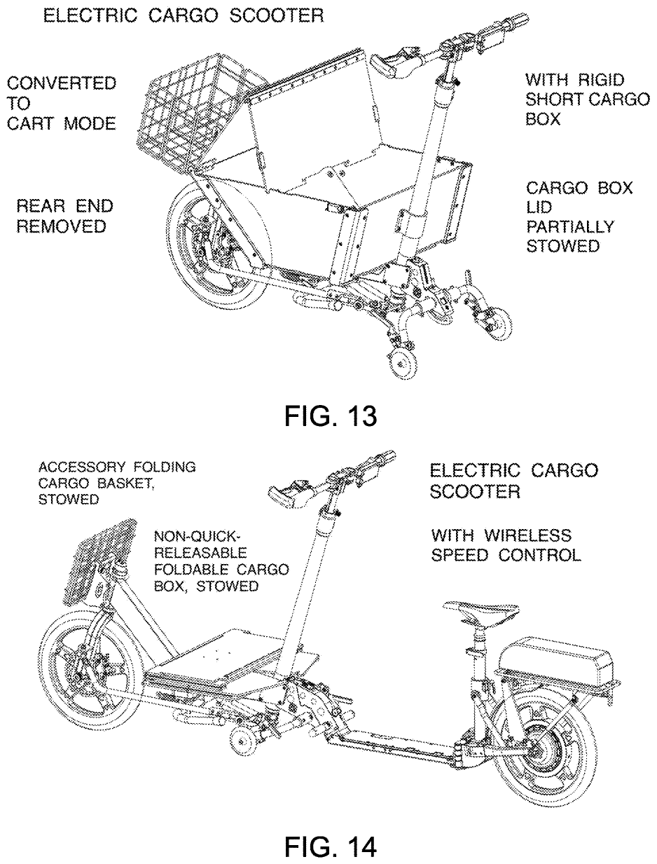

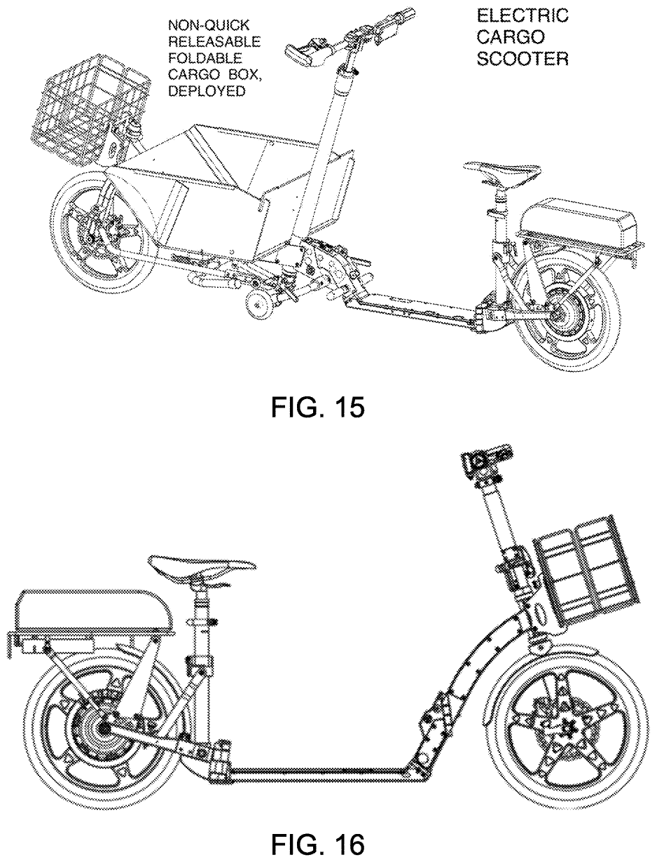

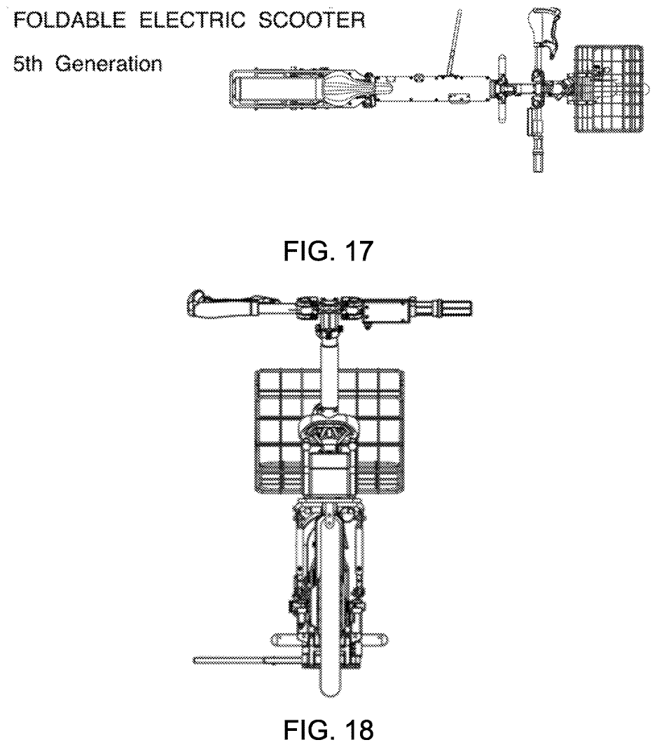

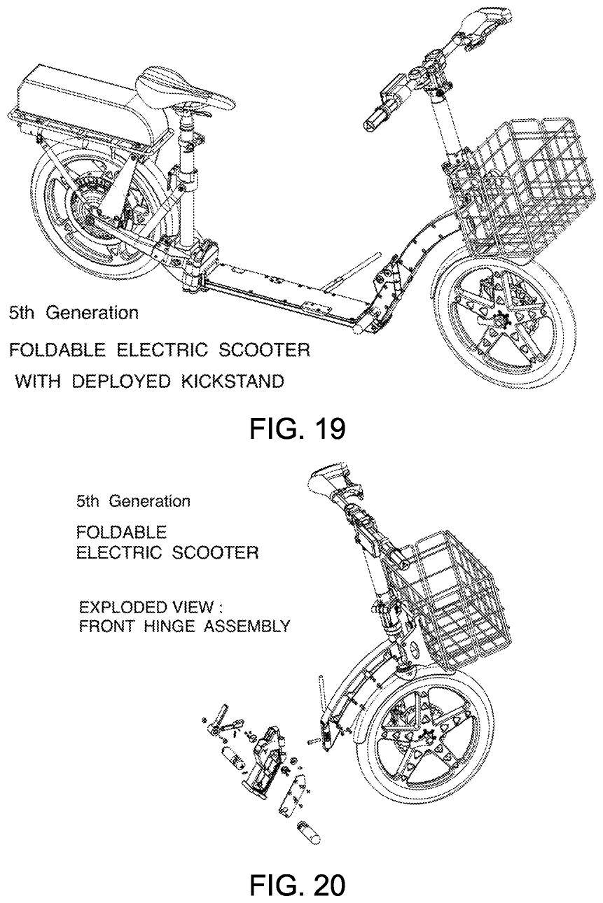

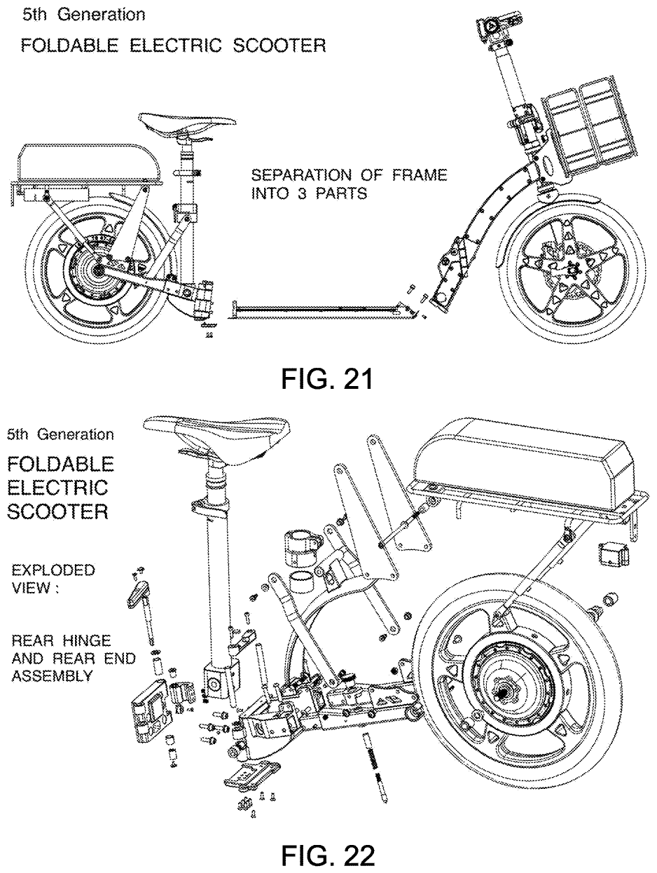

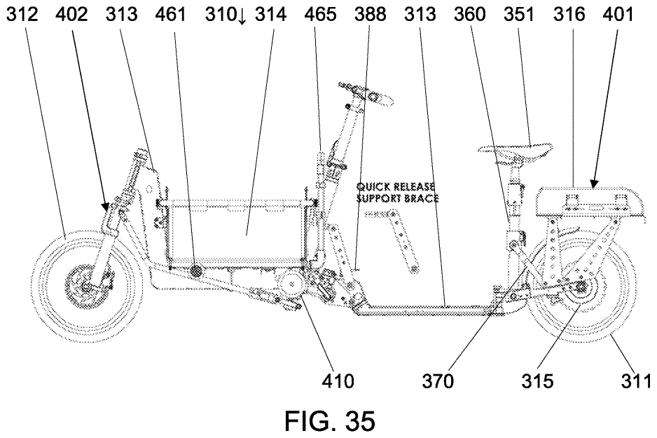

As shown in FIG. 35, cargo scooter 310 includes seat 351 that a user can (e.g., optionally) sit on when riding scooter 310. In this embodiment, cargo scooter 310 further includes seat column 360 that supports seat 351 from frame 313, and strut adjuster 370 that extends from frame 313 to seat column 360. In this embodiment, strut adjuster 370 is configured to be adjusted (e.g., by the user) to adjust fore and aft position of seat 351. An exploded view of a strut adjustor is also shown in FIG. 1. In a number of embodiments, the strut adjuster (e.g., 370) is adjusted by altering length of the strut adjuster. Further, in the embodiment shown, seat column 360 pivots where seat column 360 connects to frame 313, for example. Still further, in the embodiment depicted, seat column 360 is a telescoping seat tube (e.g., configured to be adjusted by the user) to adjust height of seat 351. Even further, in various embodiments, the cargo hold (e.g., 314) is a cargo box and the cargo box (i.e. cargo hold 314) is mounted in front of the user when the user is riding (e.g., on seat 351) on scooter 310. Examples of cargo boxes are show, for instance, in FIGS. 9, 10, 12-15, 31, 35-47, & 49-51. Another type of a cargo hold is a cargo basket. Cargo baskets are show, for example, in FIGS. 1, 4-10, & 12-21.

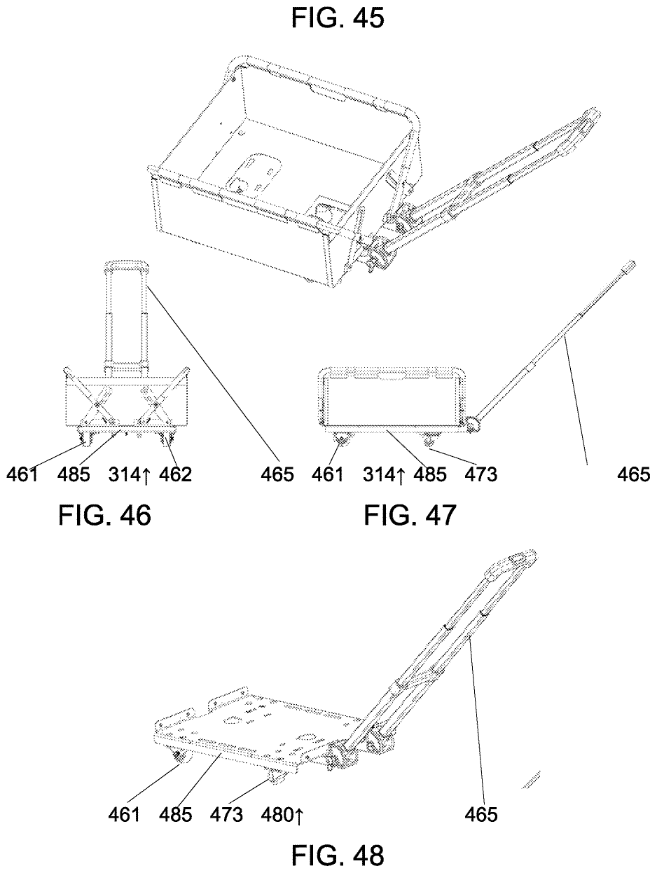

Further, in some embodiments, the scooter includes (e.g., four, for instance, in addition to other wheels described herein) cargo hold wheels. In certain embodiments, for example, the cargo hold is configured to be: disconnected from the scooter and pushed or pulled on the (e.g., four) cargo hold wheels, for instance, by the user, for example, when the user is walking. FIG. 12 illustrates, for example, a cargo scooter with a quick-release cargo hold, that is a cargo box. In contrast, FIG. 14 illustrates, for another example, a cargo scooter with a non-quick-release cargo hold, that is a foldable cargo box. Further still, FIGS. 45-47 show cargo box 314 that has been disconnected from the scooter (e.g., 310) to be pushed or pulled on the cargo hold wheels, for instance, by the user, for example, when the user is walking. Two of the four cargo hold wheels are shown in each of FIGS. 46 & 47. In particular, FIG. 46 shows cargo hold wheels 461 & 462 and FIG. 47 shows cargo hold wheel 473. A fourth cargo hold wheel, not visible in these views, would be similar or identical to cargo hold wheel 473. Cargo hold wheels are also visible in FIGS. 31, 35, 37-42, & 44. FIGS. 46-47 also show telescoping handle 465 that the user uses to push or pull cargo hold 314 when cargo hold 314 is disconnected (e.g., as shown in 45-47) from the scooter (e.g., 310) and the user is walking. The telescoping handle is also visible in FIGS. 31 & 35-44.

In some embodiments, the scooter includes a platform-style hand truck, for example, that has two caster wheels and two fixed wheels, and in particular embodiments, the platform-style hand truck is removable from the scooter and is usable for transporting cargo separately from the scooter. FIG. 48 shows an example, platform-style hand truck 480, that includes platform 485. Platform 485 is also shown in FIGS. 46 & 47 and is part of cargo hold 314. In this example, the cargo box of cargo hold 314 sits on platform 485, & the cargo box has been removed from platform 485 in FIG. 48. In the embodiment shown, platform-style hand truck 480 includes two caster wheels 473 (only one of which is visible) and two fixed wheels. Fixed wheel 461 is the only fixed wheel which is visible in FIG. 48, but fixed wheel 462 is shown in FIG. 46. In this example, platform-style hand truck 480 is removable from scooter 310 and is usable for transporting cargo separately from scooter 310. The platform (e.g., 485) is also visible, although not labeled, in FIGS. 35 & 38-42.

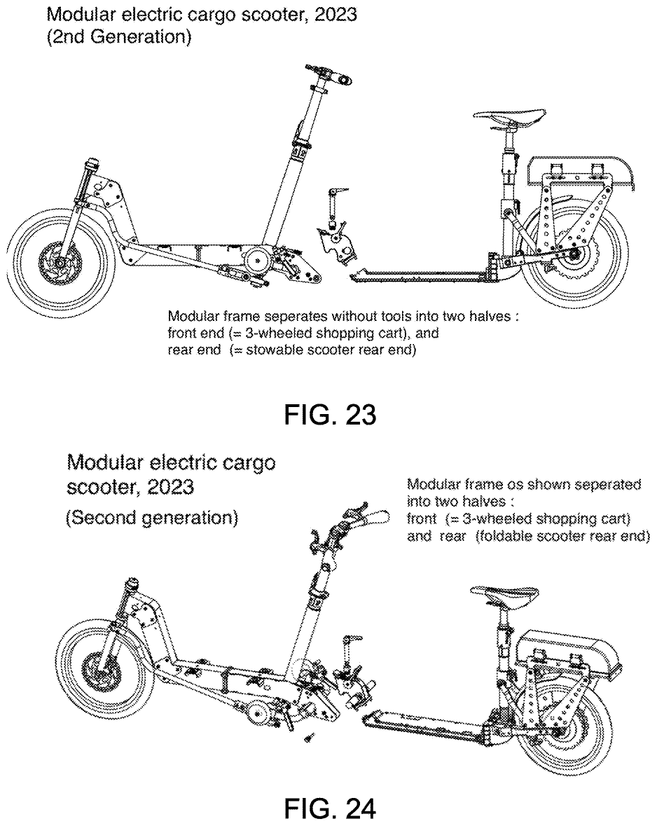

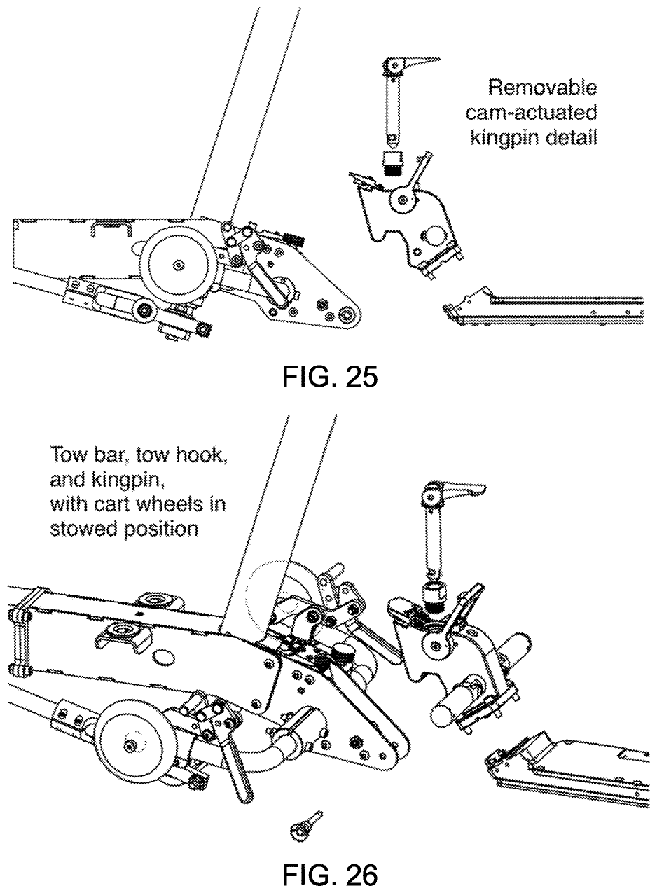

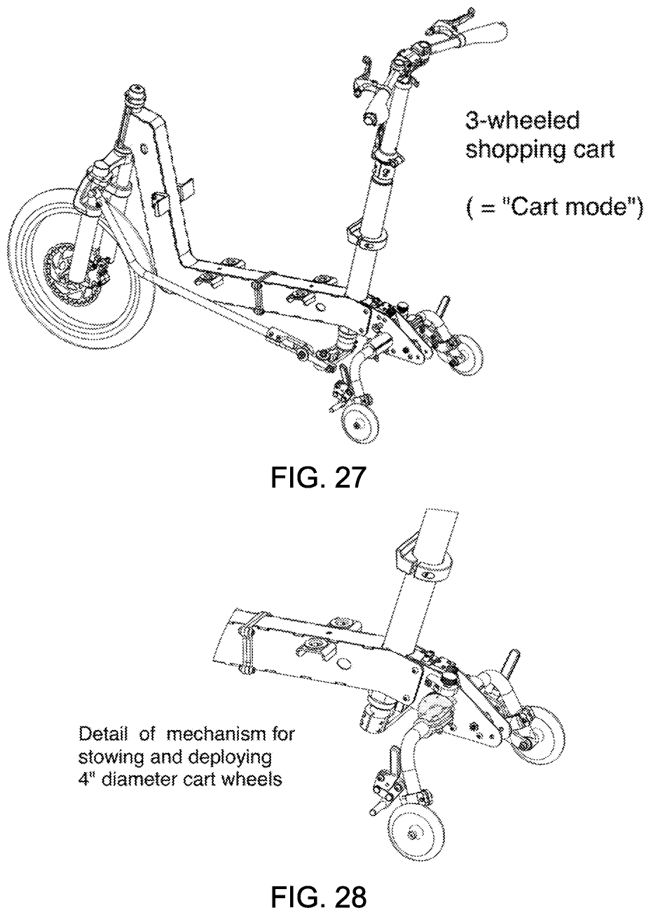

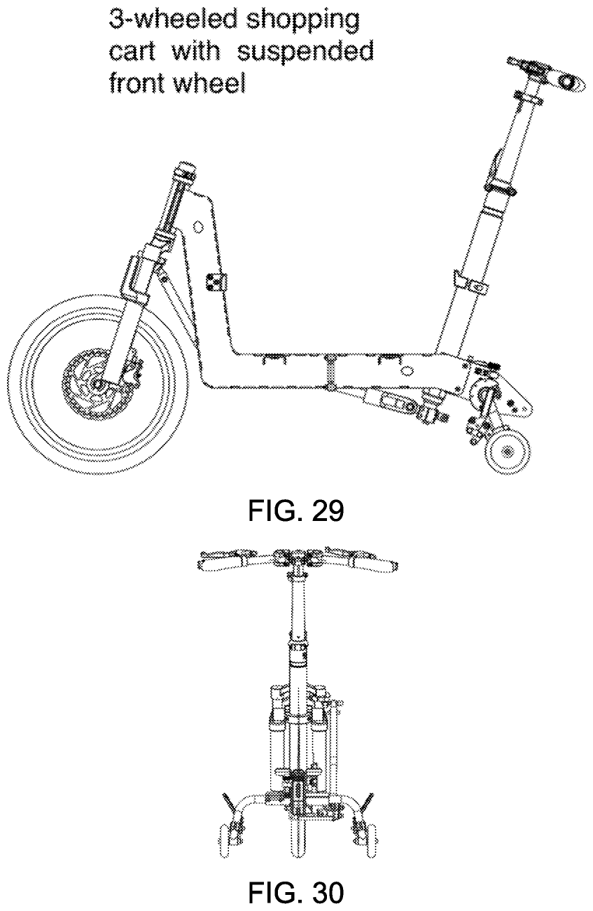

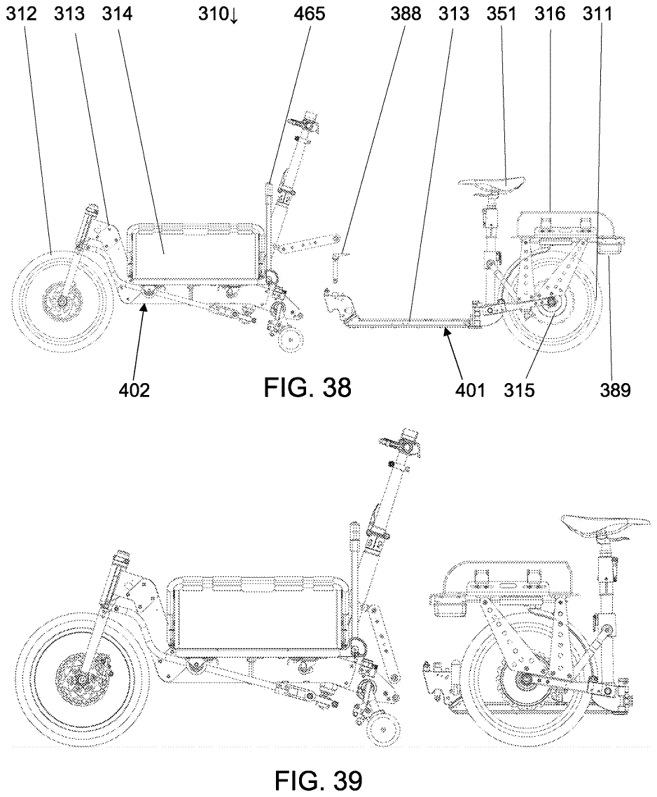

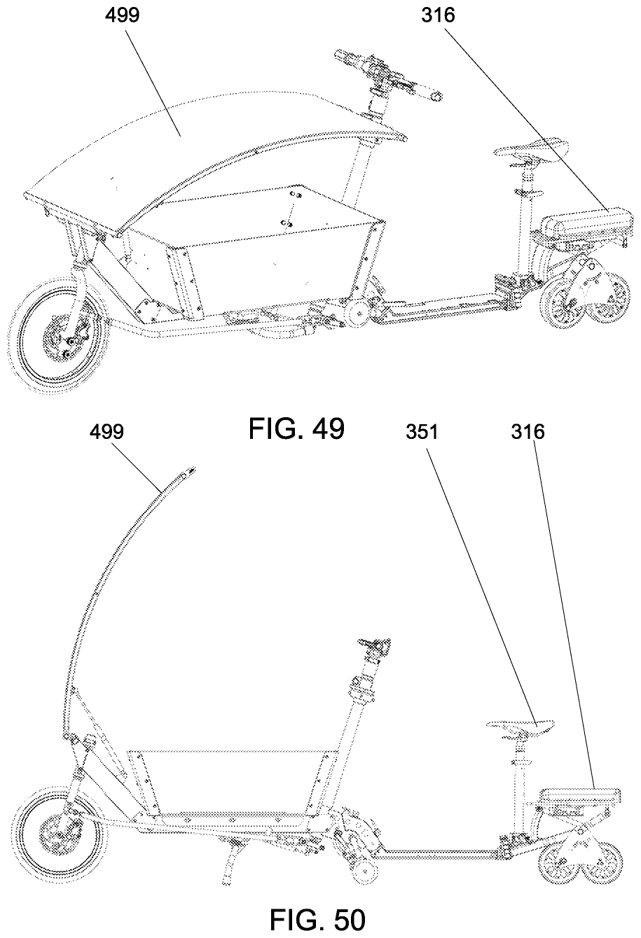

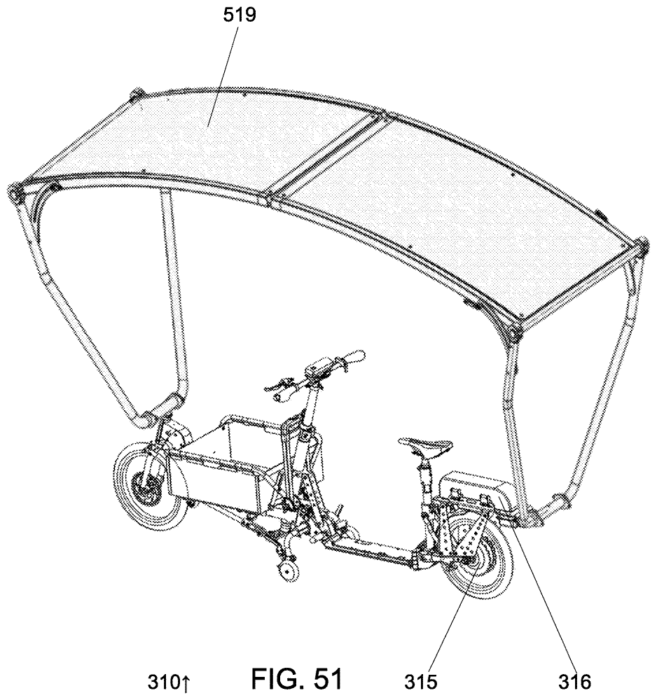

In certain embodiments, the scooter includes a kingpin, for example, a cam-actuated kingpin. In the embodiment illustrated, for example, in FIG. 38, scooter 310 includes cam-actuated kingpin 388, which is also partially shown and labeled in FIG. 35. As shown in FIG. 38, in the embodiment depicted, front part 401 of scooter 310 separates from rear part 402 of the scooter with kingpin 388. Cam-actuated kingpins are also shown in in other figures, including FIGS. 10, 14, 15, 23-26, 31, 32, & 49-51. As shown in FIG. 50, for example, some embodiments include two kingpins. Further, in the embodiment shown, electric scooter 310 includes electric motor 315 that drives first wheel 311. In this example, electric motor 315 is located inside a hub of first wheel 311. See, for instance, FIGS. 31, 35, 38, & 40. Further still, in the embodiment illustrated, electric scooter 310 includes battery 316 that powers electric motor 315. Even further, as shown in FIGS. 38, 40, & 41, in the embodiment depicted, scooter 310 includes controller 389 that controls electric motor 315. Even further still, in certain embodiments, for example, as shown in FIGS. 49-51, the scooter includes a solar panel (e.g., 499 or 519) that charges the battery (e.g., 316), powers the electric motor (e.g., 315), or both. In FIGS. 49 & 50, solar panel 499 covers the cargo box of the scooter shown, which is an embodiment of a scooter that has two rear wheels. Otherwise, the scooter shown in these figures may be similar to other scooters described herein. FIG. 51 shows solar canopy 519 mounted on scooter 310. Depending on the design, solar canopy 519 may be relatively heavy for two-wheeled cargo scooter 310. To alleviate this concern, solar canopy 519 may be used on a scooter that has 3 wheels, for example, to enhance stability.

Still other embodiments include various methods, for example, of performing functions described herein. Each method, for example, includes at least certain acts. Various embodiments include an apparatus or method of obtaining or providing an apparatus or information, for instance, that include a novel combination of the features described herein. Even further embodiments include at least one means for accomplishing at least one functional aspect described herein. The subject matter described herein includes various means for accomplishing the various functions or acts described herein or that are apparent from the structure and acts described. Each function described herein is also contemplated as a means for accomplishing that function, or where appropriate, as a step for accomplishing that function. Moreover, various embodiments include certain (e.g., combinations of) aspects described herein. All novel combinations that are feasible are potential embodiments. Some embodiments may include a subset of elements described herein and various embodiments include additional elements as well.

Further, various embodiments of the subject matter described herein include various combinations of the acts, structure, components, and features described herein, shown in the drawings, described in any documents that are incorporated by reference herein, or that are known in the art. Moreover, certain procedures can include acts such as manufacturing, obtaining, or providing components that perform functions described herein or in the documents that are incorporated by reference. Further, as used herein, the word “or”, except where indicated otherwise, does not imply that the alternatives listed are mutually exclusive. Even further, where alternatives are listed herein, it should be understood that in some embodiments, fewer alternatives may be available, or in particular embodiments, just one alternative may be available, as examples.

What is claimed is:

1. A scooter comprising: a first wheel; a second wheel; a frame; and a cargo hold; wherein the cargo hold accepts and stows a rear part of the scooter; which is detached from a front part of the scooter.

2. The scooter of claim 1 wherein: the rear part of the scooter is detached from the front part of the scooter to transform the scooter from a deployed rideable state into a configuration to be used as a shopping cart so that a user can keep the scooter with the user while in a retail environment.

3. The scooter of claim 2 further comprising: two auxiliary wheels that can each be deployed into a position in which the auxiliary wheels contact the ground, and thereby convert the scooter into the configuration to be used as the shopping cart.

4. The scooter of claim 2 wherein: the shopping cart rolls on at least three wheels while the scooter is in the configuration to be used as the shopping cart.

5. The scooter of claim 2 wherein the cargo hold is configured to carry the rear part of the scooter; and, when the scooter is in the configuration to be used as the shopping cart, the shopping cart is pushed by the user in front of the user while the user is walking.

6. The scooter of claim 2 wherein:
one of the first wheel and the second wheel is a front wheel of the scooter;
the front wheel of the scooter also serves as a front wheel of the configuration used as the shopping cart while the user is shopping in the retail environment.

7. The scooter of claim 1 wherein: the rear part of the scooter is folded before being stowed in the rear part of the scooter.

8. The scooter of claim 1 further comprising:
a seat that a user can optionally sit on when riding the scooter;
a seat column that supports the seat from the frame; and
a strut adjuster that extends from the frame to the seat column;
wherein the strut adjuster is configured to be adjusted by the user to adjust fore and aft position of the seat.

9. The scooter of claim 8 wherein: the strut adjuster is adjusted by altering length of the strut adjuster.

10. The scooter of claim 8 wherein: the seat column pivots where the seat column connects to the frame.

11. The scooter of claim 8 wherein: the seat column is a telescoping seat tube configured to be adjusted by the user to adjust height of the seat.

12. The scooter of claim 1 wherein: the cargo hold is a cargo box and the cargo box is mounted in front of the user, when the user is riding on the scooter.

13. The scooter of claim 1 further comprising four cargo hold wheels wherein the cargo hold is configured to be: disconnected from the scooter; and pushed or pulled on the four cargo hold wheels by the user when the user is walking.

14. The scooter of claim 13 further comprising a telescoping handle that the user uses to push or pull the cargo hold when the cargo hold is disconnected from the scooter and the user is walking.

15. The scooter of claim 1 further comprising a platform-style hand truck comprising: two caster wheels: and two fixed wheels: wherein the platform-style hand truck is: removable from the scooter; and is usable for transporting cargo separately from the scooter.

16. The scooter of claim 1 further comprising a kingpin, wherein the front part of the scooter separates from the rear part of the scooter with the kingpin.

17. The scooter of claim 16 wherein the kingpin is cam actuated.

18. The scooter of claim 1 further comprising:
an electric motor that drives the first wheel;
a battery that powers the electric motor; and
a controller that controls the electric motor.

19. The scooter of claim 18 wherein the scooter further comprises a solar panel that charges the battery.
